(19) United States
(12) Patent Application Publication
(10) Pub. No.: US 2023/0013895 A1
(43) Pub. Date: Jan. 19, 2023

(54) IN SITU CATALYST DEPOSITION AND UTILIZATION

(71) Applicant: AVIUM LLC, Lawrence, KS (US)

(72) Inventors: Mark Alan Daugherty, Wauwatosa, WI (US); Kevin Charles Leonard, Lawrence, KS (US); Timothy Rotermund Larson, Lawrence, KS (US); Joseph Mohammad Barforoush, Lawrence, KS (US)

(21) Appl. No.: 17/811,007

(22) Filed: Jul. 6, 2022

Related U.S. Application Data
(60) Provisional application No. 63/218,681, filed on Jul. 6, 2021.

(51) Int. Cl. C25B 1/04; C25B 13/00; C25B 9/19; C25B 11/089

(52) U.S. Cl. CPC C25B 1/04; C25B 13/00; C25B 9/19; C25B 11/089

(57) ABSTRACT

Disclosed herein is an electrolyte comprising OH⁻ and a hydrogen evolution electrocatalyst, an oxygen evolution electrocatalyst, a bifunctional hydrogen/oxygen evolution electrocatalyst, or any combination thereof for use in in situ deposition or utilization.

### CROSS-REFERENCE TO RELATED APPLICATIONS

The present application claims priority to U.S. patent application Ser. No. 63/218,681, filed Jul. 6, 2021, the entire contents of which are hereby incorporated by reference.

### FIELD OF THE INVENTION

The disclosed technology is generally directed to electrocatalysts. More particularly the technology is directed to methods and systems for maintaining high efficiency hydrogen production from non-carbon containing sources and for servicing an electrolyzer stack.

### BACKGROUND OF THE INVENTION

The development of efficient, earth-abundant electrocatalysts for the water splitting reactions, i.e., the hydrogen evolution reaction (HER) and the oxygen evolution reaction (OER), is of great importance as the world switches to a carbon free economy. In an electrolyzer the HER occurs on a cathode electrode while the OER occurs on an anode electrode. Traditionally, electrodes are coated with electrocatalysts prior to assembly of an electrolyzer stack, which consists of repeating cells comprising a cathode and anode with a separator in between the anode and cathode and a bipolar plate between cells. Once integrated with the balance of plant for operation, the stack is typically non-serviceable and must eventually be replaced entirely due to decrease in efficiency over time. Typical stack replacement intervals for alkaline electrolyzers are in a range of 60,000 h to 100,000 h. The end of life for a stack is typically marked by a degradation in efficiency to below approximately 90% of the initial value. Replacement of stacks is a significant capital cost, ranging from 45-50% of the initial capital cost of the total system. Stack replacement also requires the electrolyzer to be shut down, disassembled, and reassembled. Therefore, methods and systems for maintaining high efficiency and for servicing a stack without needing to shut down, disassemble, or reassemble the stack are needed.

### BRIEF SUMMARY OF THE INVENTION

Disclosed herein methods, systems, and compositions for maintaining high efficiency and for servicing an electrolyzer stack without needing to shut down, disassemble, or reassemble the stack. One aspect of the invention provides for an electrolyte comprising OH⁻ and a hydrogen evolution electrocatalyst, an oxygen evolution electrocatalyst, a bifunctional hydrogen/oxygen evolution electrocatalyst, or any combination thereof.

Another aspect of the technology provides for a separator electrode assembly comprising: an electrode, wherein the electrode comprises a plurality of openings therethrough; a separator, wherein the electrode contacts the separator and the separator has an electrolyte-exposed surface defined by the plurality of openings; and an electrocatalyst, wherein the electrocatalyst is deposited on the electrode and the electrolyte-exposed surface of the separator and wherein the electrocatalyst is a hydrogen evolution electrocatalyst, an oxygen evolution electrocatalyst, a bifunctional hydrogen/oxygen evolution electrocatalyst, or any combination thereof.

Another aspect of the invention provides for an alkaline electrolyzer comprising any of the separator electrode assemblies and/or any of the electrolytes described herein.

Another aspect of the invention provides for a reactor system comprising an electrolyzer and further comprising a pump configured to circulate the electrolyte through the electrolyzer.

Another aspect of the invention provides for a method for depositing electrocatalysts. The method may comprise recirculating any of the electrolytes described herein through an electrolyzer or reactor under conditions sufficient for depositing the hydrogen evolution electrocatalyst, the oxygen evolution electrocatalyst, the bifunctional hydrogen/oxygen evolution electrocatalyst, or any combination onto an electrode. In some embodiments, deposition occurs simultaneously with a hydrogen evolution reaction or an oxygen evolution reaction.

These and other aspects of the invention will be further described herein.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

In order to simplify terminology we refer to an electrode on which the OER will occur during normal water splitting operation as an anode electrode and an electrode on which the HER will occur during normal water splitting operation as a cathode electrode. For purposes of catalyst deposition, a positive or a negative potential may be applied to either a cathode electrode or an anode electrode.

FIG. 1: An illustration of an alkaline electrolyzer cell.

FIG. 2A: An illustration of an arrangement of electrodes in alkaline electrolysis cell.

FIG. 2B: A top-view schematic of a Separator Electrode Assembly (SEA), including an electrically conducting mesh electrode 110, a separator which prevents product gases from mixing and allows ion transport between anode and cathode 100, and catalyst 120 coating both the electrode and the separator.

FIG. 2C: A cross-sectional schematic of a Separator Electrode Assembly (SEA), including an electrically conducting mesh electrode 110, a separator 100, and catalyst 120 coating both the electrode and the separator.

FIG. 3: Diagram of Configuration 1 where catalyst(s) are mixed with electrolyte, then pumped through the system using one pump, and is effective in improving performance of the OER, the HER or both the OER and HER. The improvement in performance can be due to operation as an electrochemical slurry reactor and/or to the deposition of catalysts on the electrodes and/or separator.

FIG. 4: Diagram of Configuration 2 where an OER catalyst, an HER catalyst, or both an OER and HER catalyst may be utilized. Each catalyst can be mixed with electrolyte and run through the corresponding side in independent recirculation loops to prevent mixing. Each catalyst improves performance on its respective side. The improvement in performance can be due to operation as an electrochemical slurry reactor and/or the deposition of catalysts on the electrodes and/or separator.

FIG. 5A: Configuration 3 is used to illustrate a process with multiple steps. Many configurations for such processes are possible and they may include different hardware configurations. OER, HER, or both OER and HER catalysts may be deposited on an anode electrode and/or cathode electrode and/or separator using a Configuration 3 process. FIG. 5A is a diagram of the first step of a Configuration 3 deposition process in which the OER catalyst is mixed with electrolyte and circulated through the system at a given current density with the leads set to apply a negative potential to the anode electrode. The leads are shown with a negative potential on the anode electrode, but they can be switched to apply a positive potential on the anode electrode as needed for optimal deposition. With a negative potential on the anode electrode, hydrogen evolution will occur on the anode electrode during deposition.

FIG. 5B: In the second step of this Configuration 3 deposition, the system is drained and refilled with an HER catalyst mixed with electrolyte and circulated through the system at a given current density with the leads set to apply a negative potential to the cathode electrode. The leads are shown with a negative potential on the cathode electrode, but they can be switched to apply a positive potential on the cathode electrode as needed for optimal deposition.

FIG. 5C: After steps one and two of this Configuration 3 process are completed the electrodes and/or separator have been coated with the corresponding catalysts, and clean electrolyte (electrolyte without the addition of catalyst) is pumped into the system which then operates as an electrolyzer with the newly deposited catalysts.

FIG. 6: An electrolyzer system with an integrated apparatus for Configuration 3 deposition/regeneration.

FIG. 7: Estimate of stack efficiency over time for in situ stack regeneration using the present invention and a typical alkaline electrolyzer using the stack replacement method. This estimate is based on both stacks operating at the same current density.

FIG. 8: Chronopotentiometry operation at different current levels with no catalyst in aqueous 30 wt % KOH (squares) followed by chronopotentiometry with 2.0% v/v Co catalyst in aqueous 30 wt % KOH solution using Configuration 1 (triangles), with the anode electrode positive. A voltage reduction of approximately 0.2 V is achieved with this method. The data was obtained in a bench-scale electrolyzer with titanium endplates/flow fields and 1 cm² Ni mesh electrodes at 0.1 A for 6 minutes and subsequently at 0.2 A, 0.3 A, 0.4 A, and 0.5 A for 2 minutes each (referred to in later figure descriptions with the abbreviated phrase: “0.1-0.5 A chronopotentiometry run”).

FIG. 9: Chronopotentiometry operation at different current levels with 2.0% v/v Co catalyst in aqueous 30 wt % KOH solution using Configuration 1, anode electrode positive. The data was obtained in a bench-scale electrolyzer with titanium endplates/flow fields and 1 cm² Ni mesh electrodes at 0.1 A for 6 minutes and subsequently at 0.2 A, 0.3 A, 0.4 A, 0.5 A, 0.6 A, 0.7 A, 0.8 A, 0.9 A, and 1.0 A for 2 minutes each. The data at higher current densities was taken at 1.1 A for 6 minutes and subsequently at 1.2 A, 1.3 A, 1.4 A, 1.5 A, 1.6 A, 1.7 A, 1.8 A, 1.9 A, and 2.0

A for 2 minutes each. This data set is a continuation of the experiments detailed in the FIG. 8 description. The 0.1-2.0 A chronopotentiometry run (squares) was preceded by two 0.1-0.5 A chronopotentiometry runs (not shown). The 0.1-1.0 A chronopotentiometry run (diamonds) was preceded by 20 hours of operation (not shown) with 2.0% v/v Co catalyst in aqueous 30 wt % KOH solution using Configuration 1, anode electrode positive at a current density of 0.3 A cm².

FIG. 10: Chronopotentiometry operation at different current levels with no catalyst (squares), 0.25% (crosses), 0.5% (triangles), 1.0% (asterisks), and 2.0% (circles) v/v Co catalyst in aqueous 30 wt % KOH solution using Configuration 1, anode electrode positive. The electrolyzer was first operated with no catalyst for six 0.1-0.5 A chronopotentiometry runs (squares, run with lowest voltage is shown) to establish a baseline. The electrolyzer was then operated with 0.1% v/v Co catalyst in aqueous 30 wt % KOH for two 0.1-0.5 A chronopotentiometry runs (not shown). The concentration of Co catalyst was increased to 0.25% v/v in aqueous 30 wt % KOH for one 0.1-0.5 A chronopotentiometry run (crosses), then to 0.5% v/v for two 0.1-0.5 A chronopotentiometry runs (triangles, run with lowest voltage is shown), then to 1.0% v/v for three 0.1-0.5 chronopotentiometry runs (asterisks, run with lowest voltage is shown), then to 2% v/v for four 0.1-0.5 A chronopotentiometry runs (circles, run with lowest voltage is shown). The data shows a decrease in cell potential as catalyst concentration in the electrolyte is increased. The data was obtained in a bench-scale electrolyzer with stainless steel endplates/flow fields and 1 cm² Ni mesh electrodes at 0.1 A for 6 minutes and subsequently at 0.2 A, 0.3 A, 0.4 A, and 0.5 A for 2 minutes each.

FIG. 11: Chronopotentiometry data with 0.50% v/v Co catalyst in aqueous 30 wt % KOH solution using Configuration 1, anode electrode positive. The electrolyzer was first operated with no catalyst for four 0.1-0.5 A chronopotentiometry runs (not shown) to establish a baseline. The electrolyzer was then operated with 0.1% v/v Co catalyst in aqueous 30 wt % KOH for 1 hour at 0.3 A (not shown) followed by one 0.1-0.5 A chronopotentiometry run (not shown). The concentration of Co catalyst was increased to 0.25% v/v in aqueous 30 wt % KOH and the electrolyzer was operated for 24 hours at 0.3 A (not shown) followed by one 0.1-0.5 A chronopotentiometry run (not shown). The concentration of Co catalyst was increased to 0.5% v/v in aqueous 30 wt % KOH and the electrolyzer was operated for two 0.1-0.5 A chronopotentiometry runs (not shown) before the 16 hour chronopotentiometry at 0.3 A (black line). The data was obtained in a bench-scale electrolyzer with stainless steel endplates/flow fields and 1.2 cm² Ni mesh electrodes at 0.3 A (0.25 A cm⁻²) for 16 hours.

FIG. 12: Chronopotentiometry data with 2.0% v/v Co catalyst in aqueous 30 wt % KOH solution using Configuration 1, anode electrode positive. This data is a continuation of the experiments detailed in the FIG. 11 description. Following the sequence of experiments detailed in the FIG. 11 description, three 0.1-0.5 A chronopotentiometry runs were performed with 0.50% v/v Co catalyst in aqueous 30 wt % KOH solution (not shown). The concentration of Co catalyst was increased to 0.75% v/v in aqueous 30 wt % KOH and the electrolyzer was operated for five 0.1-0.5 A chronopotentiometry runs (not shown). The concentration of Co catalyst was increased to 1.25% v/v in aqueous 30 wt % KOH and the electrolyzer was operated for three 0.1-0.5 A chronopotentiometry runs (not shown), then for one 0.1-0.5 A chronopotentiometry run with each current (0.1, 0.2, 0.3, 0.4, and 0.5) applied for 10 minutes each (not shown), followed by one 0.1-0.5 A chronopotentiometry run (not shown). The concentration of Co catalyst was increased to 2.0% v/v in aqueous 30 wt % KOH and the electrolyzer was operated for three 0.1-0.5 A chronopotentiometry runs (not shown), then for one 0.1-0.5 A chronopotentiometry run with each current applied for 9 minutes each (not shown), followed by one 0.1-0.5 A chronopotentiometry run (not shown) before the 24 hour chronopotentiometry at 0.3 A (black line). A reduction in voltage is seen compared to the data shown in FIG. 11, which used 0.5% Co catalyst. The data was obtained in a bench-scale electrolyzer with stainless steel endplates/flow fields and 1.2 cm² Ni mesh electrodes at 0.3 A (0.25 A/cm²) for 24 hours.

FIG. 13: Chronopotentiometry operation at different current levels with 0.25%, 0.75%, 1.5%, 2.0%, and 4.0% FeNi catalyst in aqueous 30 wt % KOH solution was used for this

Configuration 3 process. The electrolyzer was first operated with no catalyst for two 0.1-0.5 A chronopotentiometry runs (not shown) with the anode electrode positive, then the anode electrode was switched to negative. With the anode electrode negative, two 0.1-0.5 A chronopotentiometry runs were performed with no catalyst (squares, run with lowest voltage is shown). The electrolyzer was then operated with 0.25% v/v FeNi catalyst in aqueous 30 wt % KOH for two 0.1-0.5 A chronopotentiometry runs (diamonds, run with lowest voltage is shown). The concentration of FeNi catalyst was increased to 0.75% v/v in aqueous 30 wt % KOH for four 0.1-0.5 A chronopotentiometry runs (triangles, run with lowest voltage is shown). The concentration of FeNi catalyst was increased to 1.5% v/v in aqueous 30 wt % KOH for two 0.1-0.5 A chronopotentiometry runs followed by chronopotentiometry at 0.3 A for 15 hours (shown in FIG. 14) and an additional four 0.1-0.5 A chronopotentiometry runs (diagonal crosses, run with lowest voltage is shown). The concentration of FeNi catalyst was increased to 2.0% v/v in aqueous 30 wt % KOH for two 0.1-0.5 A chronopotentiometry runs (asterisks, run with lowest voltage is shown), then to 4.0% v/v for two 0.1-0.5 A chronopotentiometry runs followed by chronopotentiometry at 0.3 A for 23 hours (shown in FIG. 15) and an additional 0.1-0.5 A chronopotentiometry run (crosses, run with lowest voltage is shown). The data shows a reduction in cell potential as the concentration of FeNi catalyst in the electrolyte is increased. The data was obtained in a bench-scale electrolyzer with stainless steel endplates/flow fields and 1 cm² Ni mesh electrodes at 0.1 A for 6 minutes and subsequently at 0.2 A, 0.3 A, 0.4 A, and 0.5 A for 2 minutes each. FIG. 14: Chronopotentiometry data with 1.5% v/v FeNi catalyst in aqueous 30 wt %

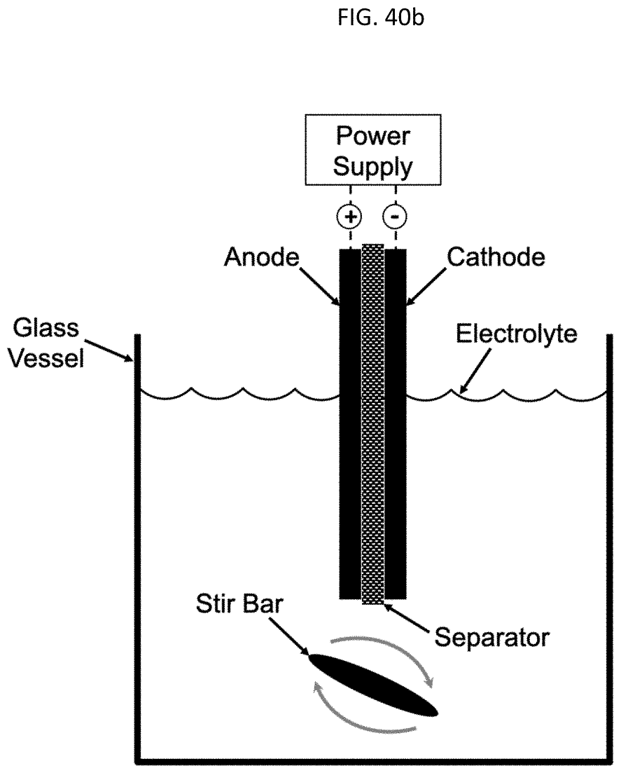

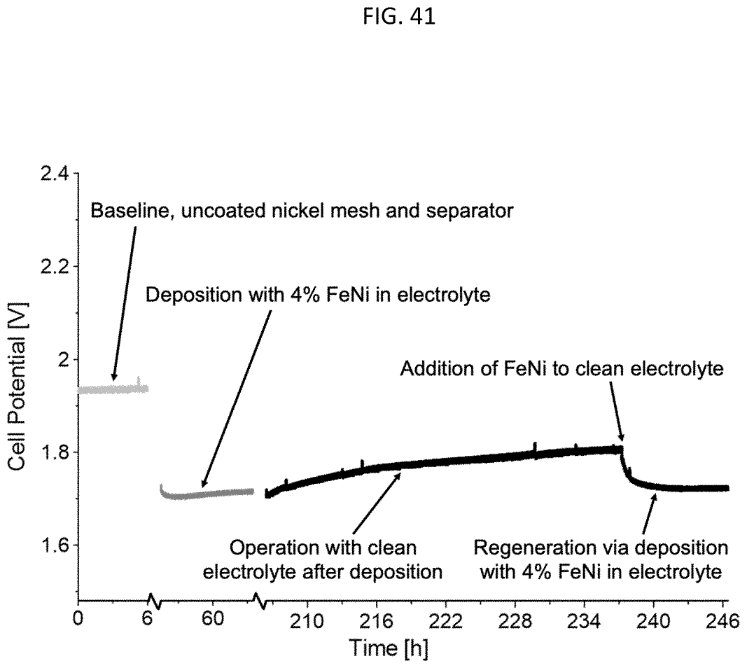

KOH solution, anode electrode negative. The reduction in cell potential suggests deposition of catalyst during the chronopotentiometry. The data was obtained in a bench-scale electrolyzer with stainless steel endplates/flow fields and 1.2 cm² Ni mesh electrodes at 0.3 A (0.25 A cm⁻²) for 16 hours. See FIG. 13 description for prior history of experiments. FIG. 15: Chronopotentiometry data with 4.0% v/v FeNi catalyst in aqueous 30 wt %

KOH solution, anode electrode negative. A reduction in voltage is seen compared to the data shown in FIG. 14, which used 1.5% FeNi catalyst. The data was obtained in a bench-scale electrolyzer with stainless steel endplates/flow fields and 1.2 cm² Ni mesh electrodes at 0.3 A (0.25 A cm⁻²) for 23 hours. See FIG. 13 description for prior history of experiments.

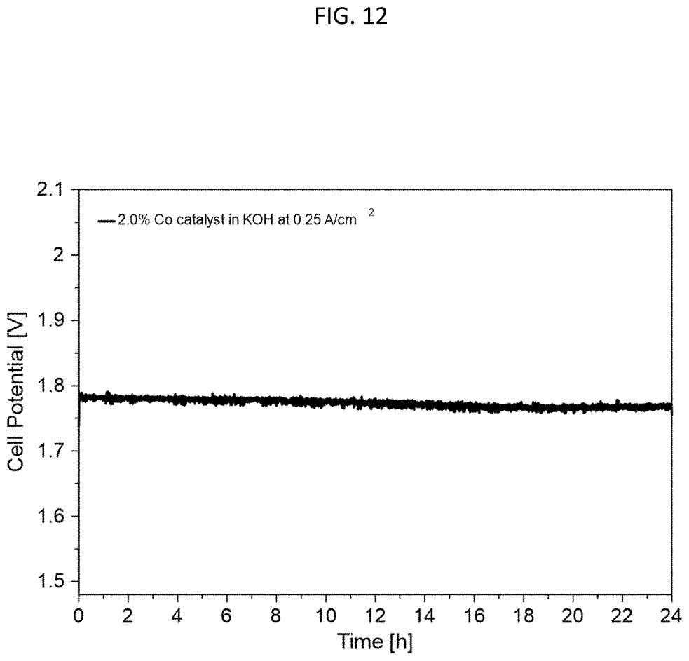

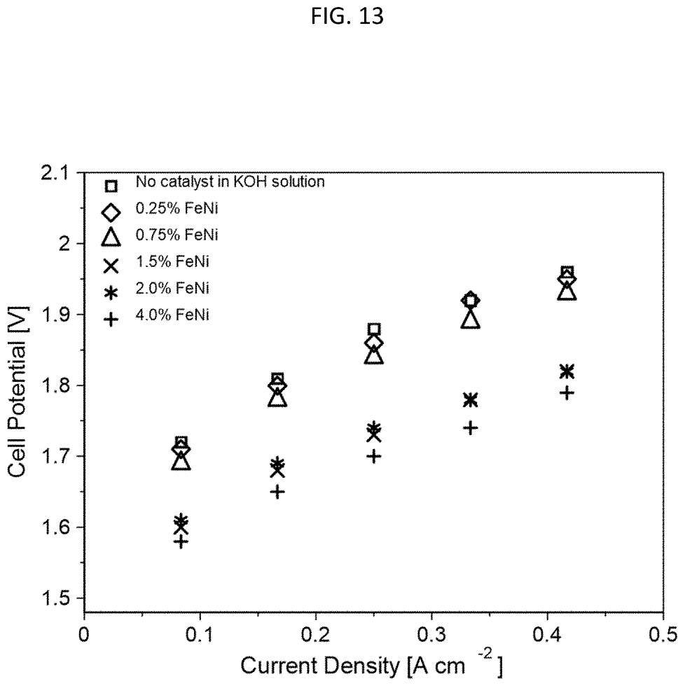

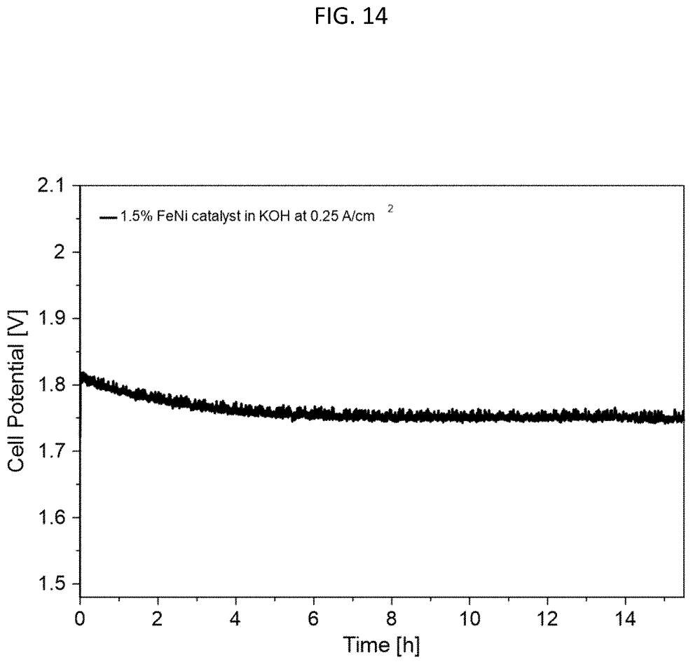

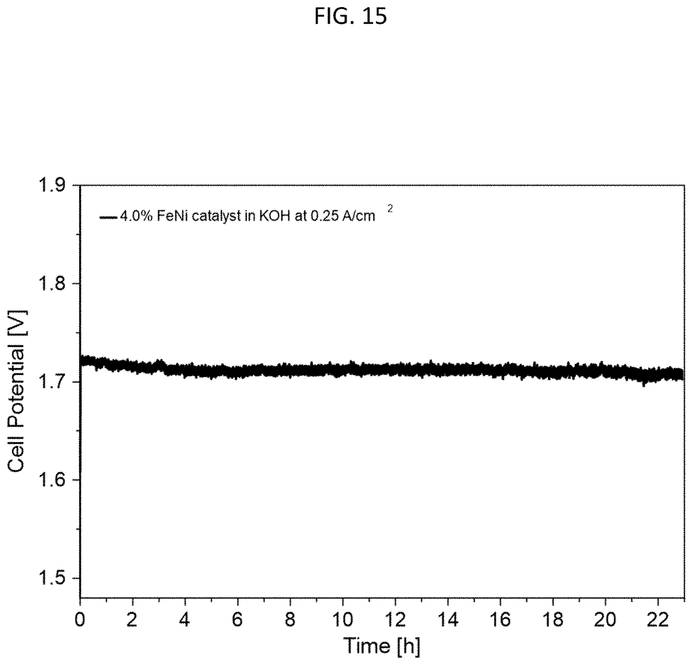

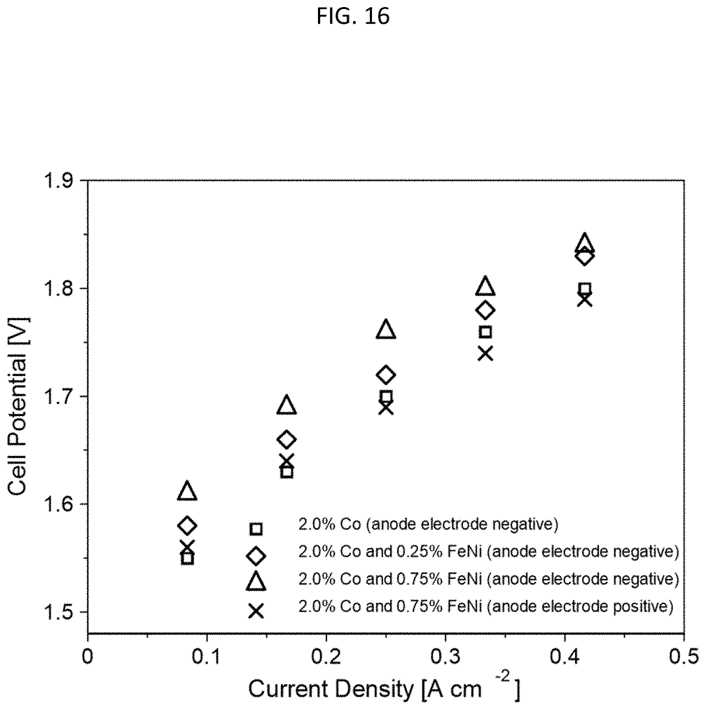

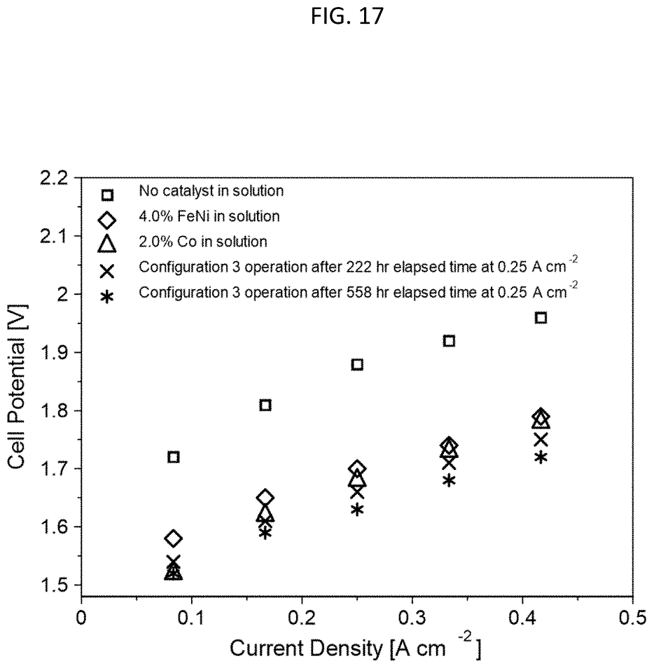

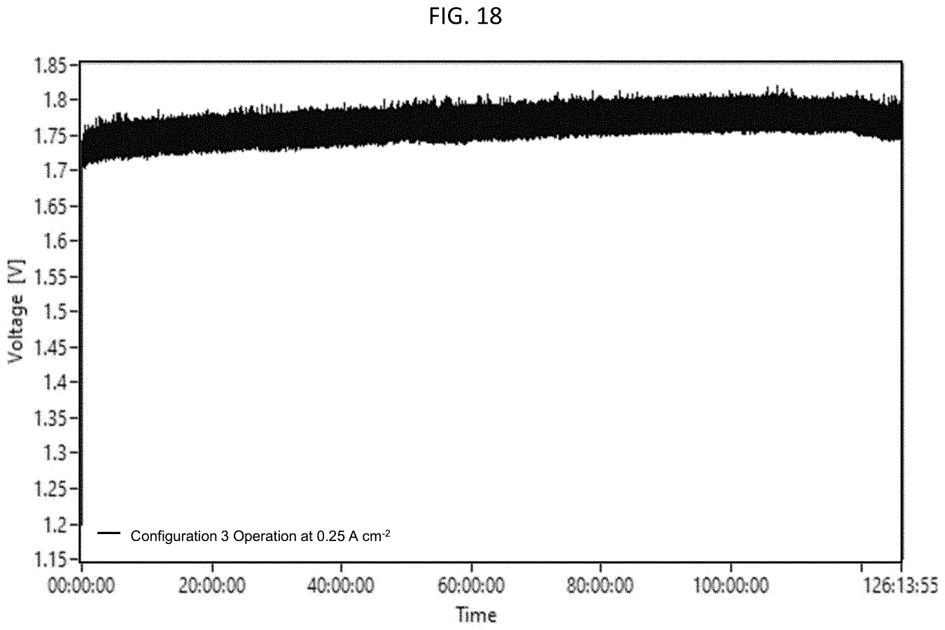

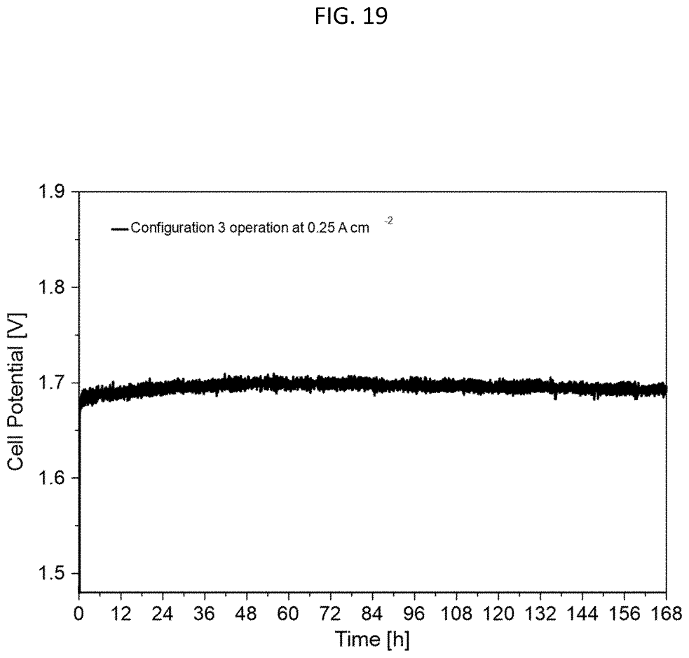

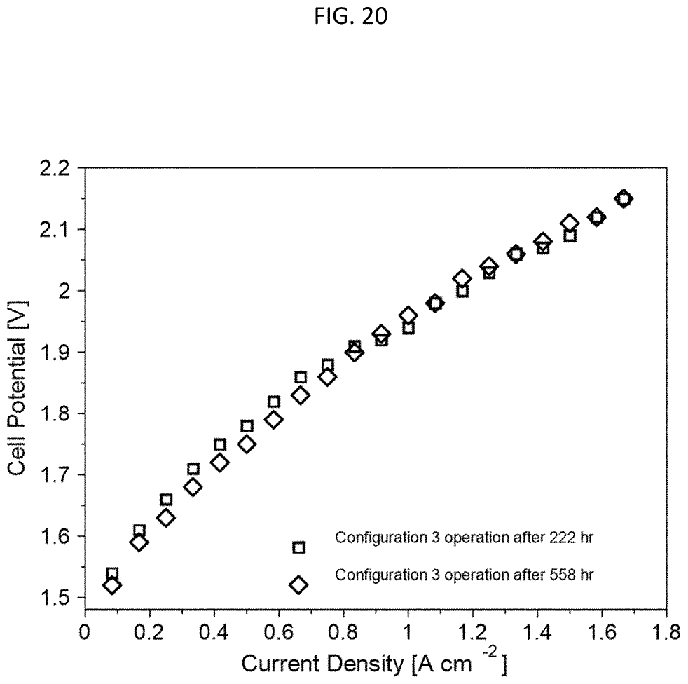

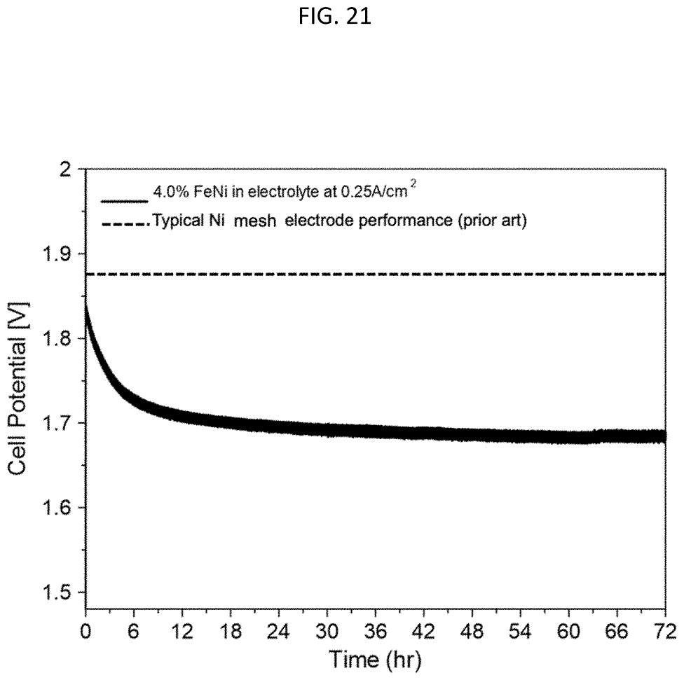

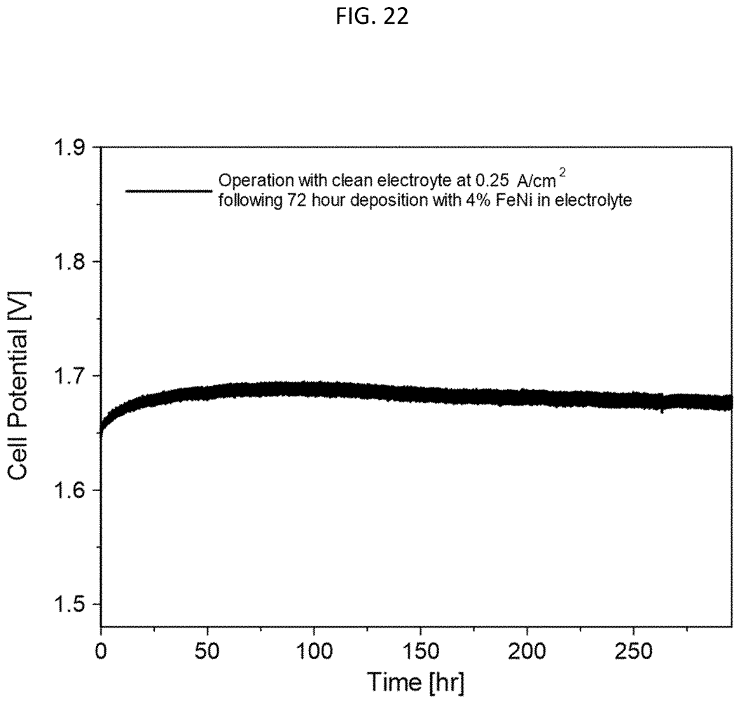

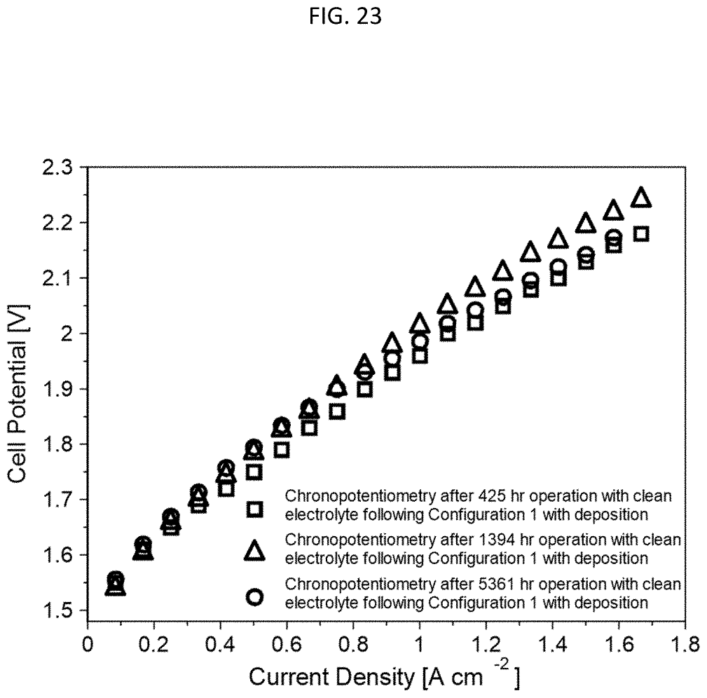

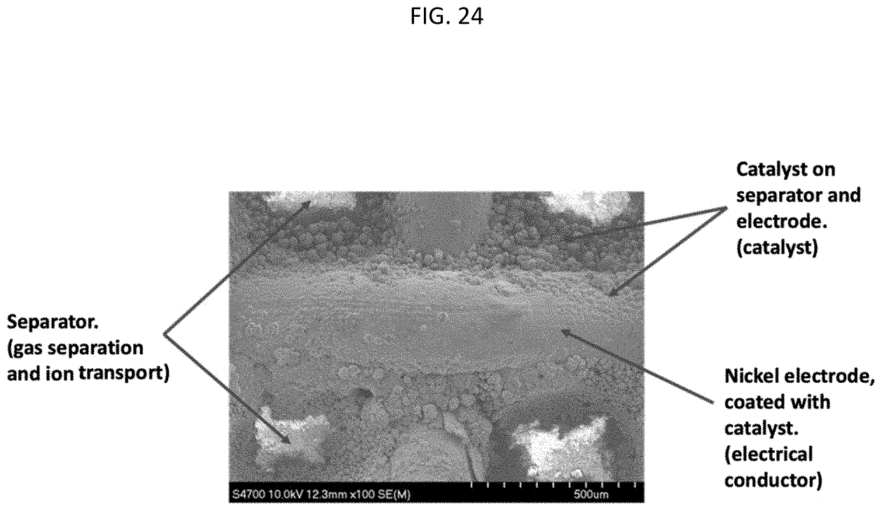

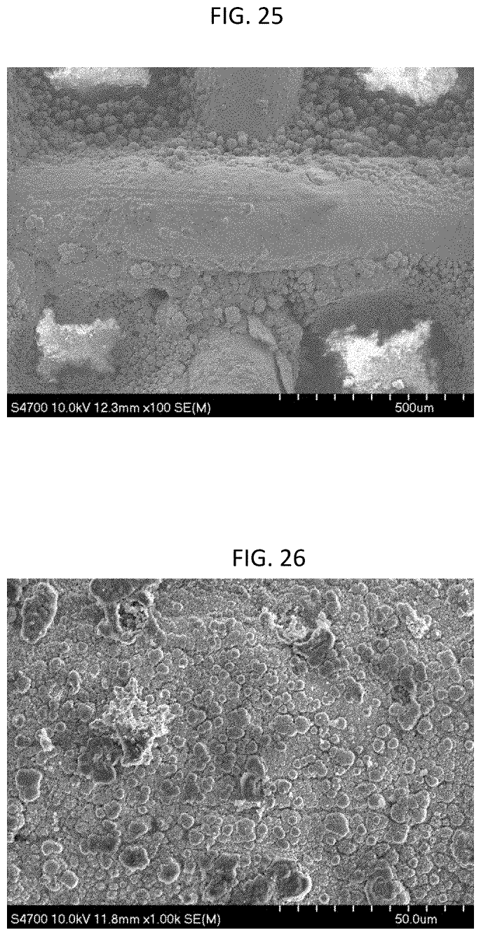

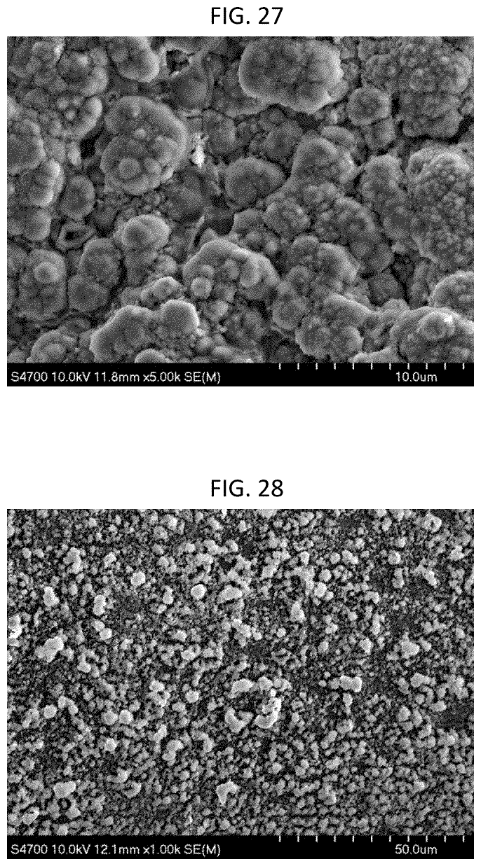

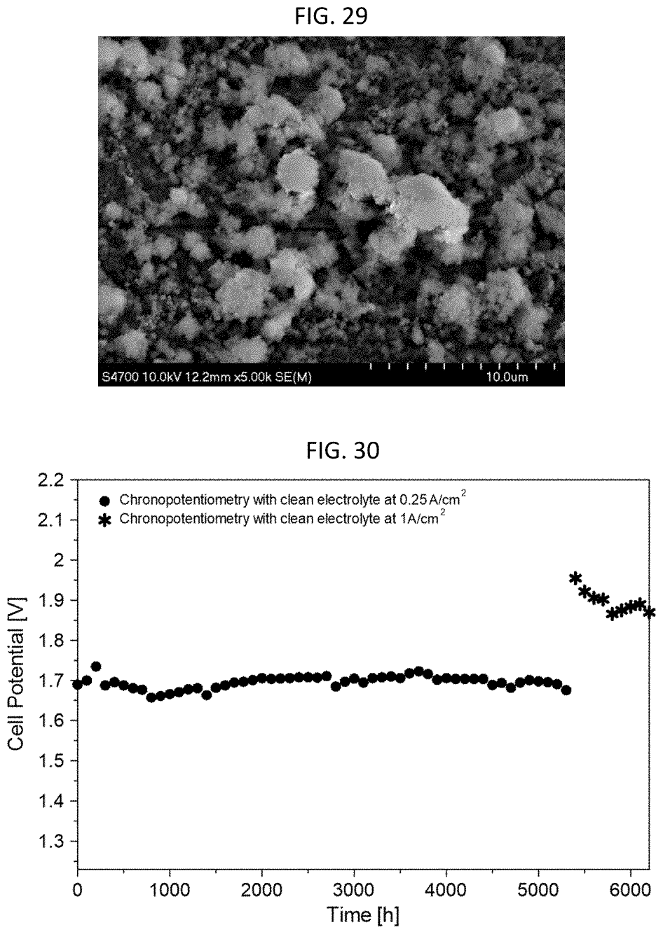

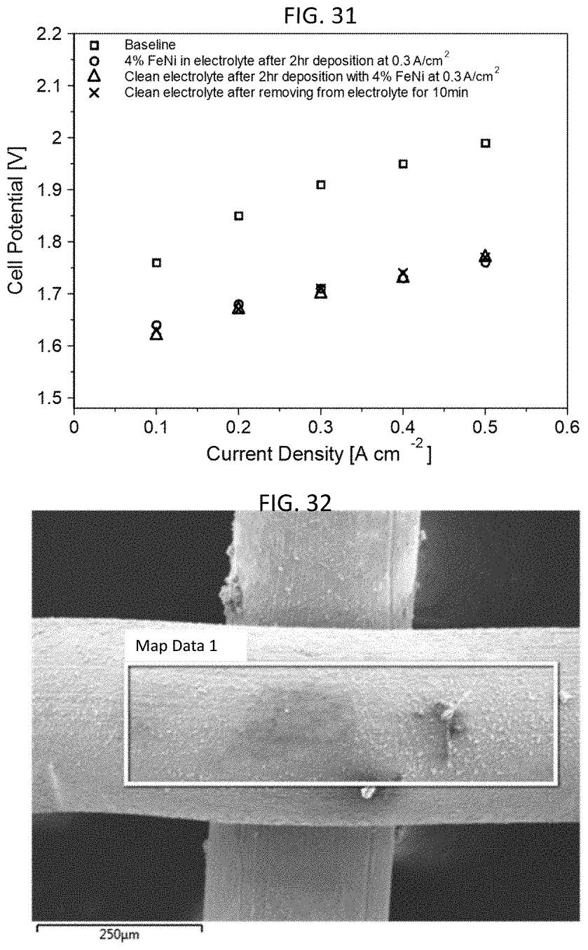

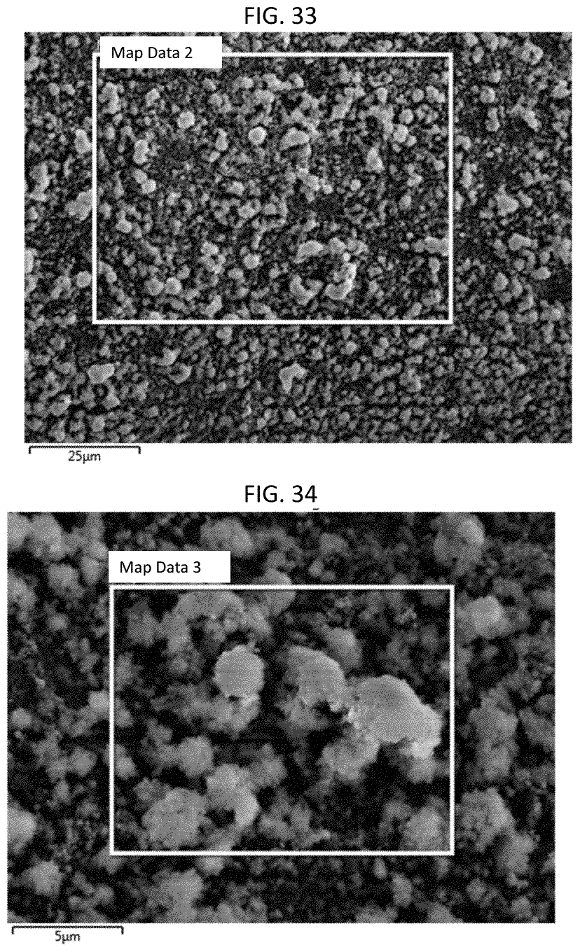

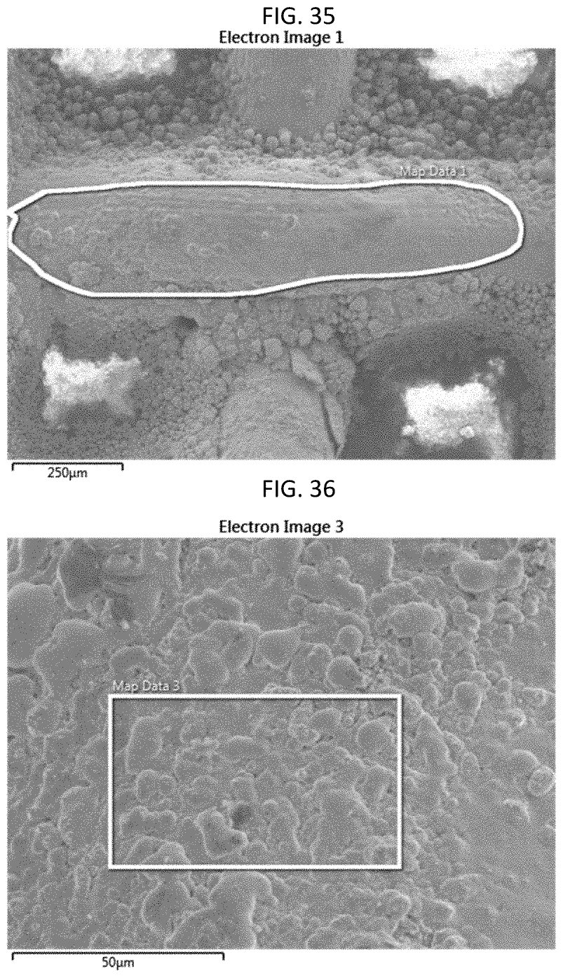

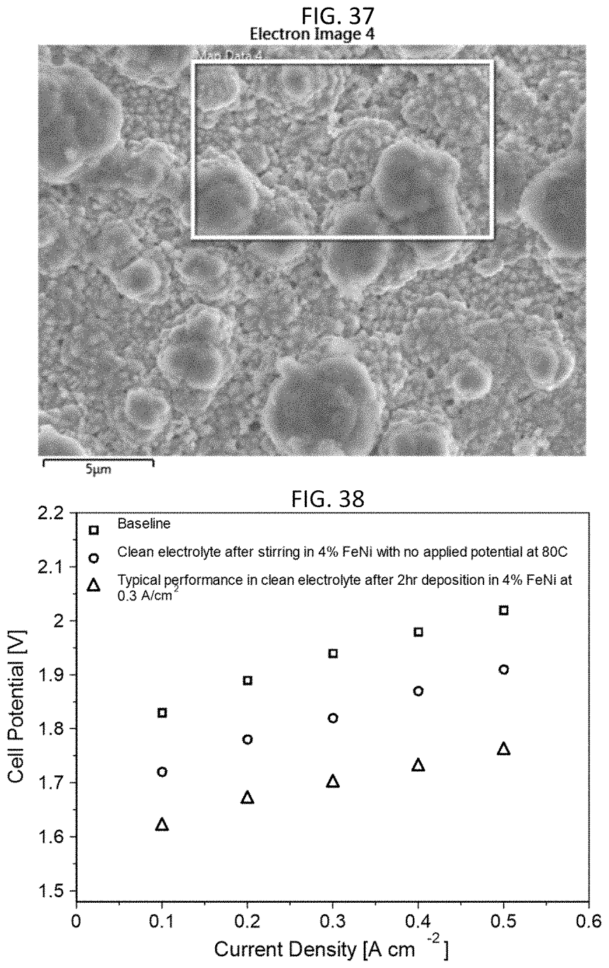

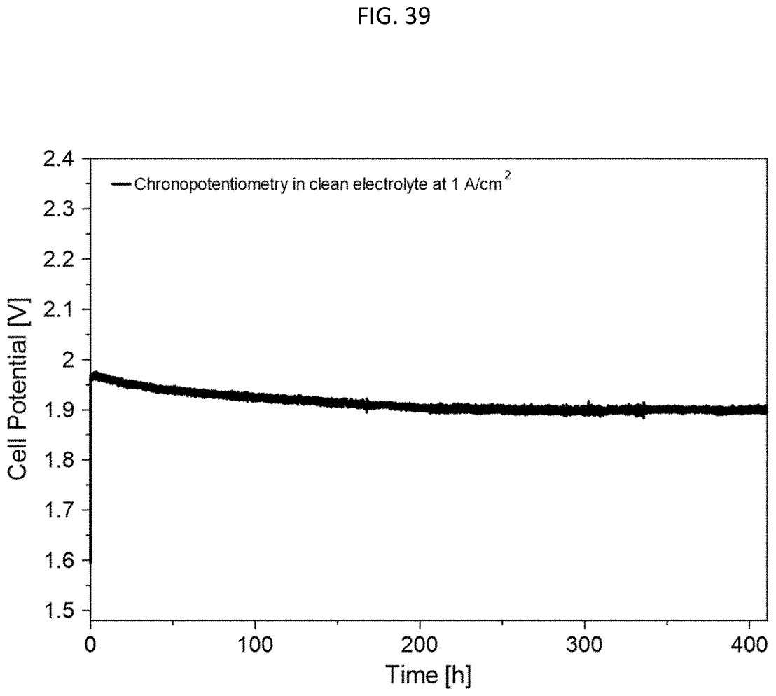

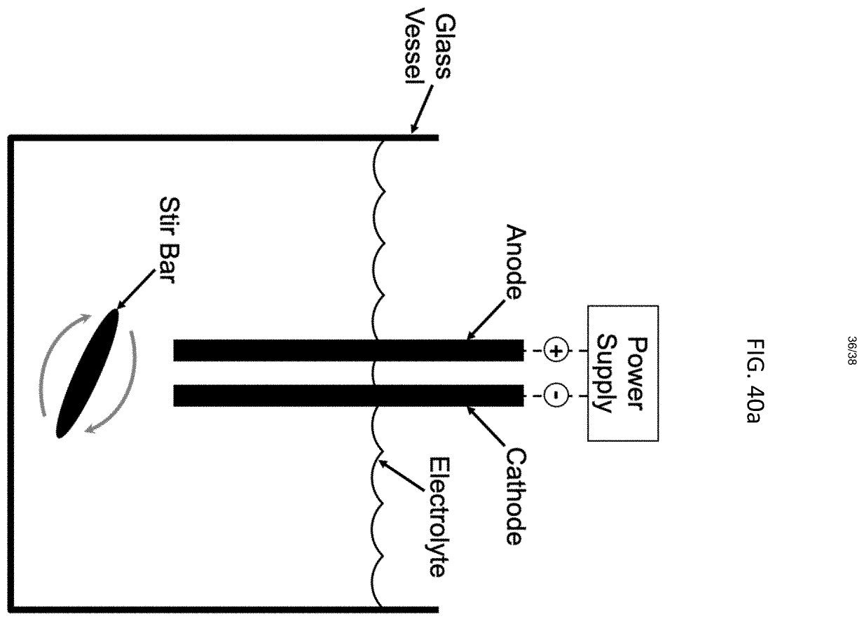

FIG. 16: Chronopotentiometry data at various current levels with 2.0% Co, 2.0% Co/0.25% FeNi, 2.0% Co/0.75% FeNi catalyst by volume in aqueous 30 wt % KOH solution. This data set is a continuation of the experiments detailed in the FIG. 12 description. Following the sequence of experiments detailed in the FIG. 12 description, four 0.1-0.5 A chronopotentiometry runs were performed with 2.0% v/v Co catalyst in aqueous 30 wt % KOH solution with anode electrode positive (not shown) followed by two 0.1-0.5 A chronopotentiometry runs with anode electrode negative (squares, run with lowest voltage is shown). Then, 0.25% FeNi v/v was added to the aqueous 30 wt % KOH solution to make a solution with both 2.0% Co and 0.25% FeNi and two 0.1-0.5 A chronopotentiometry runs were performed with anode electrode negative (diamonds, run with lowest voltage is shown) followed by chronopotentiometry at 0.3 A for 1 hour with anode electrode negative (not shown). Then, 0.75% FeNi v/v was added to the aqueous 30 wt % KOH solution to make a solution with both 2.0% Co and 0.75% FeNi and two 0.1-0.5 A chronopotentiometry runs were performed with anode electrode negative (triangles, run with lowest voltage is shown) followed by two 0.1-0.5 A chronopotentiometry runs with anode electrode switched to positive (diagonal crosses, run with lowest voltage is shown). This demonstrates the use of two different catalysts present in the electrolyte at the same time. The data was obtained in a bench-scale electrolyzer with stainless steel endplates/flow fields and 1.2 cm² Ni mesh electrodes at 0.1 A for 6 minutes and subsequently at 0.2 A, 0.3 A, 0.4 A, and 0.5 A for 2 minutes each.

FIG. 17: Configuration 3 data. This data set is a continuation of the experiments detailed in FIGS. 13, 14, and 15 descriptions. The baseline with no catalyst in solution (squares) as well as the 4.0% FeNi in solution (diamonds) data is the same as that shown in FIG. 13 with anode electrode negative. Following the sequence of experiments detailed in the FIGS. 13, 14, and 15 descriptions, the 4.0% v/v FeNi in aqueous 30 wt % KOH solution was drained from the electrolyzer and replaced with 2.0% v/v Co in aqueous 30 wt % KOH solution. The anode electrode was switched to positive for two 0.1-0.5 A chronopotentiometry runs (not shown) followed by chronopotentiometry at 0.3 A for 76 hours (not shown) and an additional two 0.1-0.5 A chronopotentiometry runs (triangles, run with lowest voltage is shown). Then, the 2.0% v/v Co in aqueous 30 wt % KOH solution was drained from the electrolyzer and replaced with clean aqueous 30 wt % KOH solution (KOH solution without the addition of catalyst). With the anode electrode positive, chronopotentiometry at 0.3 A was performed for 222 hours elapsed time (FIG. 18 shows hours 41-167) followed by two 0.1-0.5 A chronopotentiometry runs and one 0.1-2 A chronopotentiometry run with each current applied for 10 minutes (diagonal crosses, 0.1-0.5 A shown). With anode electrode positive, chronopotentiometry at 0.3 A for an additional 336 hours (FIG. 19 shows last 168 hours) followed by one 0.1-2 A chronopotentiometry run with each current applied for 10 minutes (asterisks, 0.1-0.5 A shown). The data was obtained in a bench-scale electrolyzer with stainless steel endplates/flow fields and 1.2 cm² Ni mesh electrodes at 0.1 A for 6 minutes and subsequently at 0.2 A, 0.3 A, 0.4 A, and 0.5 A for 2 minutes each unless otherwise stated.

FIG. 18: Operation with clean aqueous 30 wt % KOH solution (KOH solution without the addition of catalyst) with anode electrode positive as detailed in the FIG. 17 description. The data was obtained in a bench-scale electrolyzer with stainless steel endplates/flow fields and 1.2 cm² Ni mesh electrodes at 0.3 A (0.25 A cm⁻²) for 126 hours. See FIGS. 13, 14, 15, and 17 descriptions for full prior history of experiments.

FIG. 19: Operation with clean aqueous 30 wt % KOH solution (KOH solution without the addition of catalyst) with anode electrode positive as detailed in the FIG. 17 description. See FIGS. 13, 14, 15, and 17 descriptions for full prior history of experiments. The data was obtained in a bench-scale electrolyzer with stainless steel endplates/flow fields and 1.2 cm² Ni mesh electrodes at 0.3 A (0.25 A cm⁻²) for 168 hours.

FIG. 20: Chronopotentiometry data at various current levels with clean aqueous 30 wt % KOH (KOH solution without the addition of catalyst) at a current density of 0.25 A/cm⁻² for 222 hours (squares) and 558 hours (diamonds) with anode electrode positive. See FIGS. 13, 14, 15, and 17 descriptions for full prior history of experiments. The data was obtained in a bench-scale electrolyzer with stainless steel endplates/flow fields and 1.2 cm² Ni mesh electrodes. Each current (0.1 A through 2.0 A) was applied for 10 minutes.

FIG. 21: Configuration 1 chronopotentiometry showing deposition with 4% v/v FeNi catalyst in aqueous 30 wt % KOH solution with anode electrode positive. The data was obtained in a bench-scale electrolyzer with stainless steel endplates/flow fields and 1.2 cm² Ni mesh electrodes at 0.3 A (0.25 A cm⁻²) for 72 hours. The dotted line shows an example of the typical performance of uncoated Ni mesh electrodes in the same system without any catalyst in the electrolyte.

FIG. 22: Chronopotentiometry data with clean aqueous 30 wt % KOH solution (KOH solution without the addition of catalyst) following the deposition detailed in the FIG. 21 description, anode electrode positive. The data was obtained in a bench-scale electrolyzer with stainless steel endplates/flow fields and 1.2 cm² Ni mesh electrodes at 0.3 A (0.25 A cm⁻²) for 297 hours.

FIG. 23: Chronopotentiometry data at various current levels with clean aqueous 30 wt % KOH solution (KOH solution without the addition of catalyst) following deposition at 0.25 A cm⁻² for 72 h with 4.0% v/v FeNi in aqueous 30 wt % KOH solution and operation with clean electrolyte (electrolyte without the addition of catalyst) at 0.3 A (0.25 A cm⁻²) for 425 hours (squares), 1394 hours (triangles), and 5361 hours (circles). The data was obtained in a bench-scale electrolyzer with stainless steel endplates/flow fields and 1.2 cm² Ni mesh electrodes. Each current (0.1-2.0 A) was applied for 10 minutes.

FIG. 24: Scanning electron micrograph of cathode side of a Separator Electrode Assembly (SEA) formed in an alkaline electrolyzer with nickel mesh electrodes and Zirfon UTP 500+ separator. In the formation of the SEA, the catalyst coats the electrode and extends out onto the separator as shown in the Figure. The SEA provides intimate connection between electrical conductor (nickel mesh), catalyst, and separator. The catalyst forms a bridge between the nickel mesh electrode and the separator. This type of structure can only be formed when catalyst is deposited with both the electrode and separator present. It cannot be formed if an electrode is coated by itself with a catalyst. See Example 2 and FIGS. 13, 14, 15, and 17 descriptions for full prior history of experiments.

FIG. 25: Scanning electron micrograph of cathode side of SEA formed in an alkaline electrolyzer with nickel mesh electrodes and Zirfon UTP 500+ separator. See Example 2 and FIGS. 13, 14, 15, and 17 descriptions for full prior history of experiments.

FIG. 26: Scanning electron micrograph of catalyst coating on cathode side of SEA formed in an alkaline electrolyzer with nickel mesh electrodes and Zirfon UTP 500+ separator. See Example 2 and FIGS. 13, 14, 15, and 17 descriptions for full prior history of experiments.

FIG. 27: Scanning electron micrograph of catalyst coating on cathode side of SEA formed in an alkaline electrolyzer with nickel mesh electrodes and Zirfon UTP 500+ separator. See Example 2 and FIGS. 13, 14, 15, and 17 descriptions for full prior history of experiments.

FIG. 28: Scanning electron micrograph of catalyst coating on anode side of SEA formed in an alkaline electrolyzer with nickel mesh electrodes and Zirfon UTP 500+ separator. See

Example 2 and FIGS. 13, 14, 15, and 17 descriptions for full prior history of experiments.

FIG. 29: Scanning electron micrograph of catalyst coating on anode side of SEA formed in an alkaline electrolyzer with nickel mesh electrodes and Zirfon UTP 500+ separator. See Example 2 and FIGS. 13, 14, 15, and 17 descriptions for full prior history of experiments.

FIG. 30: Long term chronopotentiometry data with clean aqueous 30 wt % KOH solution (KOH solution without the addition of catalyst) following the deposition detailed in the FIG. 21 description, anode electrode positive. The data was obtained in a bench-scale electrolyzer with stainless steel endplates/flow fields and 1.2 cm² Ni mesh electrodes at 0.3 A (0.25 A cm⁻²) for 5,361 hours (circles). Following chronopotentiometry at 0.3 A (0.25 A cm⁻²), the electrolyzer was operated for 859 hours at 1 A cm⁻² (asterisks). The plot shown is lifetime testing with clean KOH the entire time. Some irregularities are associated with brief power outages.

FIG. 31: Chronopotentiometry at different current levels with a nickel mesh sample (cathode and anode spaced approximately 1 mm apart) under various conditions in order to determine the nature of the bonding between the catalyst and the electrode. The sample was created by depositing with 4% v/v FeNi in aqueous 30 wt % KOH for 2 hours. Chronopotentiometry at different current levels was performed (circles) before replacing electrolyte containing 4% v/v

FeNi with clean electrolyte. Another chronopotentiometry set was performed (triangles) with the clean electrolyte. The electrodes were removed from the liquid electrolyte for 10 minutes before being re-immersed in clean KOH. A final chronopotentiometry set was performed (X shapes). The baseline (squares) is data for the nickel mesh sample, prior to coating.

FIG. 32: A SEM micrograph of a nickel mesh anode exposed to deposition conditions described in Example 12. Scale bar is 250 μm. Box inset shows area analyzed by EDS.

FIG. 33: A SEM micrograph of a nickel mesh anode exposed to deposition conditions described in Example 12. Scale bar is 25 μm. Box inset shows area analyzed by EDS.

FIG. 34: A SEM micrograph of a nickel mesh anode exposed to deposition conditions described in Example 12. Scale bar is 5 μm. Box inset shows area analyzed by EDS.

FIG. 35: A SEM micrograph of a nickel mesh cathode exposed to deposition conditions described in Example 12. Scale bar is 250 μm. Box inset shows area analyzed by EDS.

FIG. 36: A SEM micrograph of a nickel mesh cathode exposed to deposition conditions described in Example 12. Scale bar is 25 μm. Box inset shows area analyzed by EDS.

FIG. 37: A SEM micrograph of a nickel mesh cathode exposed to deposition conditions described in Example 12. Scale bar is 5 μm. Box inset shows area analyzed by EDS.

FIG. 38: Chronopotentiometry at different current levels with a nickel mesh sample (cathode and anode spaced approximately 1 mm apart as shown in FIG. 40a) created by immersion in 4% v/v FeNi in aqueous 30 wt % KOH without applied potential (circles) and typical performance of a nickel mesh sample created by immersion in 4% v/v FeNi in aqueous 30 wt % KOH with applied potential (triangles). The baseline (squares) is data for the nickel mesh sample, prior to coating.

FIG. 39: Chronopotentiometry data with clean aqueous 30 wt % KOH solution (KOH solution without the addition of catalyst) following the chronopotentiometry data shown FIGS. 21, 22, 23, and 30, anode electrode positive. The data was obtained in a bench-scale electrolyzer with stainless steel endplates/flow fields and 1.2 cm² Ni mesh electrodes at 1.2 A (1 A cm⁻²) for 411 hours.

FIG. 40A: An illustration of an alkaline electrolysis test cell showing an anode electrode and cathode electrode immersed in electrolyte with a stir bar to circulate electrolyte.

FIG. 40B: An illustration of an alkaline electrolysis test cell showing an anode electrode and cathode electrode with a separator in between, in a zero gap configuration.

FIG. 41: Chronopotentiometry data from an alkaline electrolysis test cell in a zero gap configuration showing baseline data, initial deposition data with 4% v/v FeNi in aqueous 30 wt % KOH electrolyte, and increase in voltage over time followed by regeneration via addition of 4% v/v FeNi to clean electrolyte.

### DETAILED DESCRIPTION OF THE INVENTION

Disclosed herein are methods, systems, and compositions for depositing catalyst on electrodes while electrochemical reactions are occurring and regenerating catalysts in an electrolyzer stack without needing to shut down, disassemble, or reassemble the stack. The methods described herein allow for the application of fresh catalyst onto the electrodes in an alkaline electrolyzer. The present technology can significantly lower stack fabrication costs, allow for field regeneration of electrolyzer stacks, and improve stack efficiency. It has the potential to significantly lower the overall capital costs of the electrolyzer, and also allow for regular catalyst regeneration to ensure stack efficiency remains high over the entire lifetime of the system.

Some embodiments of the methods described herein also allow for catalysts to function as solid catalysts working in a liquid reaction mixture in an electrolyzer, thus enabling heterogeneous catalysis in the electrolyzer stack. This allows operation of the electrolyzer stack as an electrochemical slurry reactor. This mode can occur independently or in parallel with electrolysis using deposited catalysts. In addition, operation as an electrochemical slurry reactor, deposition of catalysts, and operation with deposited catalysts can all occur independently or simultaneously. Simultaneous operation allows for self-healing of catalysts during operation.

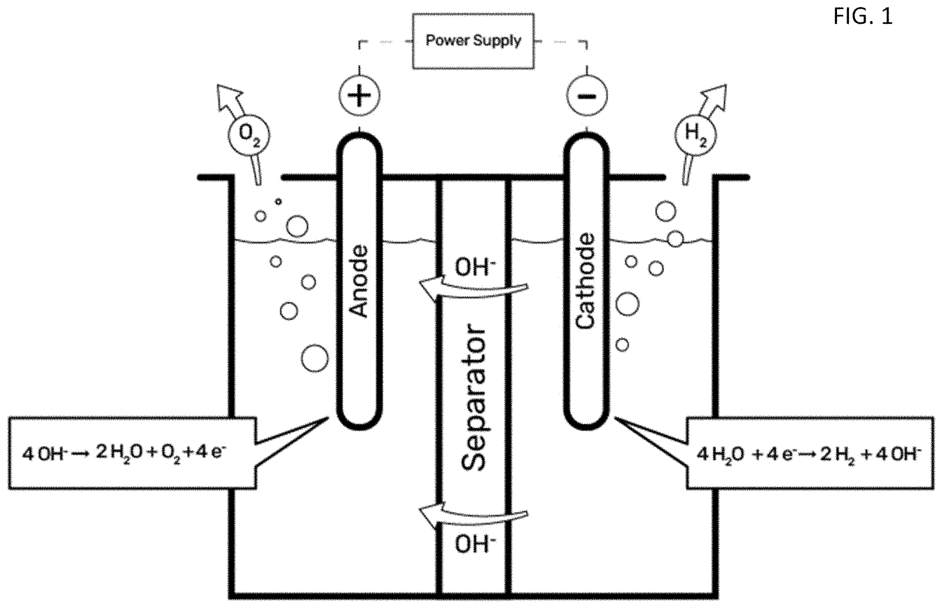

An alkaline electrolyzer is a system for the conversion of water into molecular oxygen and hydrogen. The operation of a typical alkaline electrolyzer is shown in FIG. 1. The HER occurs on the cathode (i.e., negatively charged electrode in an electrolyzer). There, water is split to generate hydrogen as described by the half-reaction:

4H₂O+4e⁻→2H₂+4OH⁻ (eqn 1).

The OER occurs on the anode (i.e., positively charged electrode in an electrolyzer). There, hydroxide ions are converted into oxygen as described by the half-reaction:

4OH⁻→2H₂O+O₂+4e⁻ (eqn 2).

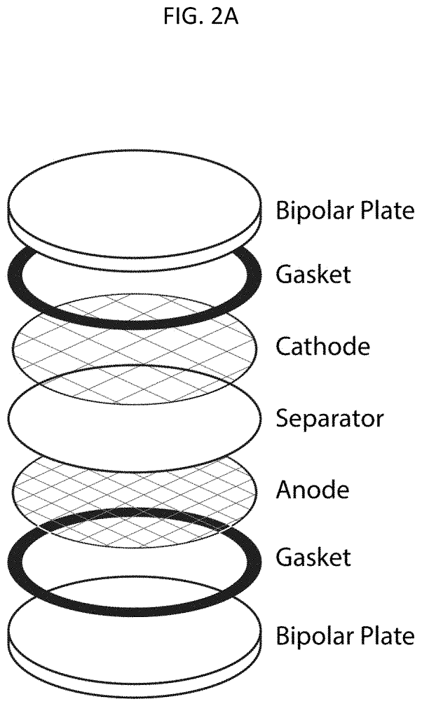

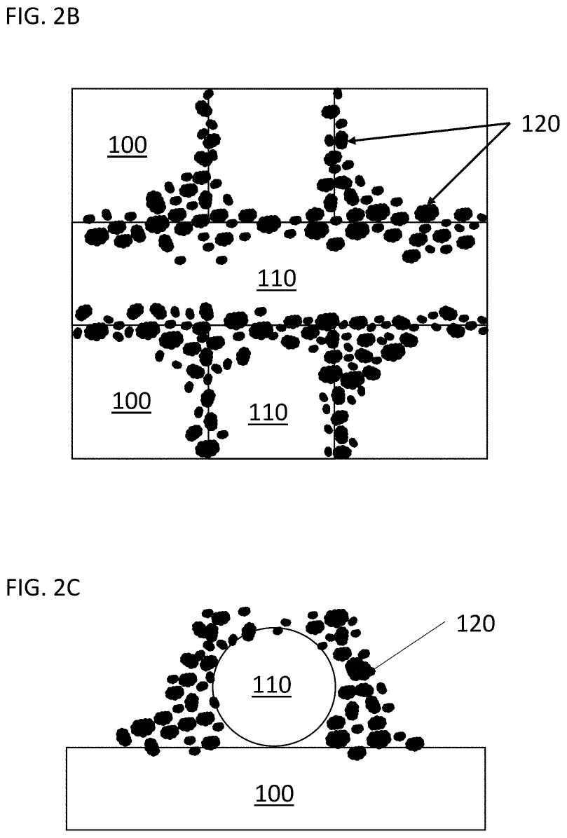

One or both of the electrodes are typically coated with electrocatalysts prior to assembly of the stack, which consists of repeating cells each comprised of a cathode and anode with a separator in between (FIG. 2A). Once integrated with the balance of plant for operation, the stack is typically non-serviceable and must eventually be replaced due to a decrease in efficiency over time.

Developing catalysts for the OER is especially challenging because the oxidation of water to oxygen occurs through a complex four-electron/four-proton transfer and many materials require a significant overpotential to drive the catalysis. Hence, the OER is the half reaction that typically limits the overall water splitting efficiency.

In some embodiments of the present invention, the OER electrocatalyst is comprised of Ni, Fe, Co, Mo, W, Cu, Mn, Ti, La, Sc, V, Y, Zr, Nb, Sr, Ba, Rb, Cs, In, Ce, Cr, Sb, Pb, Bi, Se, B, P, S, N, C, Ru, Rh, Pd, Ag, Re, Os, Au, Ir, Pt, or any combination thereof. In some embodiments, the OER electrocatalyst is comprised of 1, 2, 3, or more than 3 of any of the foregoing. In some embodiments, the OER electrocatalyst is composed of 2, 3, or more than 3 different OER electrocatalysts.

In some embodiments, the OER catalyst may be comprised of a noble metal. Exemplary noble metals include Ru, Rh, Pd, Ir, Pt, or any combination thereof.

In some embodiments, the OER electrocatalysts may be comprised of a metal electrocatalyst, metal oxide electrocatalyst, metal oxyhydroxide electrocatalyst, metal sulfide electrocatalyst, metal sulfate electrocatalyst, metal oxide-sulfide electrocatalyst, or any combination thereof. In some embodiments, the metal electrocatalyst, metal oxide electrocatalyst, metal oxyhydroxide electrocatalyst, metal sulfide electrocatalyst, metal sulfate electrocatalyst, or metal oxide-sulfide electrocatalyst is comprised of a non-precious metal.

The HER is a less energy intensive, two-electron transfer reaction. In some embodiments, the HER electrocatalyst is comprised of Ni, Fe, Co, Mo, W, Cu, Mn, Ti, La, Sc, V, Y, Zr, Nb, Sr, Ba, Rb, Cs, In, Ce, Cr, Sb, Pb, Bi, Se, B, P, S, N, C, Ru, Rh, Pd, Ag, Re, Os, Au, Ir, Pt, or any combination thereof. In some embodiments, the HER electrocatalyst is comprised of 1, 2, 3, or more than 3 of any of the foregoing. In some embodiments, the HER electrocatalyst is composed of 2, 3, or more than 3 different HER electrocatalysts.

In some embodiments, the HER electrocatalyst may be comprised of a noble metal. Exemplary noble metals include Pt or other platinum group metals.

In some embodiments, the HER electrocatalyst may be comprised of a metal electrocatalyst, metal oxide electrocatalyst, metal oxyhydroxide electrocatalyst, metal sulfide electrocatalyst, metal sulfate electrocatalyst, metal oxide-sulfide electrocatalyst, or any combination thereof. In some embodiments, the metal electrocatalyst, metal oxide electrocatalyst, metal oxyhydroxide electrocatalyst, metal sulfide electrocatalyst, metal sulfate electrocatalyst, or metal oxide-sulfide electrocatalyst are comprised of a non-precious metal.

In some embodiments, the metal oxyhydroxide electrocatalyst comprises 1, 2, 3, or more metal precursors. The metal of the electrocatalyst precursor compounds is not particularly limited. In some embodiments, the metal is a transition metal. Various transition metals may be used, including 3d transition metals such as iron (Fe), cobalt (Co) and nickel (Ni). However, other transition metals may be used, e.g., tungsten (W). Other metals such as post-transition metals and metalloids in Groups 13-16 may also be used. These include, by way of illustration, In, Sb, Pb and Bi.

In other embodiments, the metal oxyhydroxide electrocatalyst may comprise oxyhydroxides of Ni, Fe, Co, W, Cu, Mn, Mo, or any combination thereof. In some embodiments, the metal oxyhydroxide electrocatalyst is an oxyhydroxide comprised of 1, 2, 3, or more than 3 of Ni, Fe, Co, W, Cu, Mn, and/or Mo. In some embodiments, the metal oxyhydroxide electrocatalyst is composed of 2, 3, or more than 3 different metal oxyhydroxide electrocatalysts.

In some embodiments, the metal oxide electrocatalyst may comprise oxides of Ni, Fe, Co, W, Cu, Mn, Mo, or any combination thereof. In some embodiments, the metal oxide electrocatalyst is an oxide comprised of 1, 2, 3, or more than 3 of Ni, Fe, Co, W, Cu, Mn, and/or Mo. In some embodiments, the metal oxide electrocatalyst is composed of 2, 3, or more than 3 different metal oxide electrocatalysts.

In other embodiments, the metal sulfide electrocatalyst may comprise sulfides of Ni, Fe, Co, W, Cu, Mn, Mo, or any combination thereof. In some embodiments, the metal sulfide electrocatalyst is a sulfide comprised of 1, 2, 3, or more than 3 of Ni, Fe, Co, W, Cu, Mn, and/or Mo. In some embodiments, the metal sulfide electrocatalyst is composed of 2, 3, or more than 3 different metal sulfide electrocatalysts.

Exemplary metal oxyhydroxide electrocatalysts and methods of making the same are disclosed in U.S. Pat. Nos. 10,196,746 and 10,961,631. Some of the metal oxyhydroxide electrocatalysts are suitable for HER or OER and some have bifunctional activity making them suitable for both HER and OER. Bifunctional HER—OER catalysts are mainly first-row transition metal-based compounds. In some embodiments, the bifunctional HER-OER catalysts comprise Co, Ni, Fe, or any combination thereof.

The electrocatalysts used in the electrolyzers, reactors, and methods disclosed herein are provided in an alkaline electrolyte. Alkaline electrolyzers tend to operate in the range of approximately 20-45 wt % KOH, NaOH, or LiOH aqueous electrolyte. In some embodiments, the alkaline electrolyte is comprised of 25-32 wt % KOH, NaOH, or LiOH aqueous electrolyte. Suitably, the alkaline electrolyte may comprise about 30 wt % KOH.

The electrolytes described herein may comprise an effective amount of one or more electrocatalyst. An effective amount of electrocatalyst is an amount of electrocatalyst to achieve a desired effect. In some embodiments, the desired effect is to decrease the voltage required for a hydrogen evolution reaction or an oxygen evolution reaction for a given current density. In some embodiments, the desired effect may be for deposition of electrocatalyst onto an electrode and/or a separator. In some embodiments, the desired effect may be operation of an electrolyzer stack as an electrochemical slurry reactor. In some embodiments, the desired effect may be a combination of different desired effects. The effective amount of the electrocatalyst may depend on a number of different factors, including, without limitation, the composition of the electrocatalyst, the composition of the electrolyte, the particle size of the electrocatalyst, the operational configuration of the electrolyzer, or the operational configuration of a reactor system.

In some embodiments, an effective amount of an electrocatalyst may be about 0.1-10.0% v/v but higher amounts of the electrocatalyst may also be used. Suitably, the effective amount may be from about 1.0-2.0% v/v, 2.0-3.0% v/v, 3.0-4.0% v/v, 4.0-5.0% v/v, 5.0-6.0% v/v, 6.0-7.0% v/v, 8.0-9.0% v/v, or 9.0-10.0% v/v.

The electrolyte may be a suspension comprising the electrocatalyst. In some embodiments, the effective particle size of electrocatalyst suspended in the electrolyte may be from about 1 nm to about 10 microns, including any value in between. The effective particle size may be determined by those skilled in the art and may, for example, refer to a mean, mode, median, or distribution of sizes depending on context.

Electrocatalysts in aqueous suspensions are uniquely compatible with in situ deposition and utilization in electrolyzers that operate with aqueous electrolyte. Due to their stability in alkaline solutions, metal oxyhydroxides (e.g., U.S. Pat. Nos. 10,196,746, 10,961,631) are particularly well-suited for use in alkaline electrolyzers with this method.

Electrolytes may be prepared as follows. Electrocatalysts may be prepared as an aqueous suspension containing heterogeneous catalyst particles. The mass of catalyst particles in 100 mL is typically in the range of 0.01 to 100 g, but the exact amount of the catalyst in the aqueous suspension is not critical to the invention. Electrocatalysts may be prepared as disclosed in U.S. Pat. Nos. 10,196,746, and 10,961,631. In addition to the electrocatalysts, sodium nitrate may also be present in the aqueous suspension in the range of 0.01 to 1 M when these methods are used. Depending on the metal precursor compound(s) (e.g., metal salts such as metal nitrates, nitrites, sulfites, sulfates, sulfites, sulfamates) and the gelling agent (e.g., salt compounds such as bicarbonate salt of an alkali metal or an alkaline earth metal) used in the method, other byproducts may also be present in the aqueous suspension. Unreacted metal precursor compounds and/or gelling agents may also be present in the aqueous suspension. The vol % described in the Examples has been achieved with aqueous catalyst suspensions containing approximately 0.1 to 10 g of catalyst per 100 mL of liquid. This suspension is mixed with aqueous electrolyte, such as 30 wt % KOH, to produce the reported vol %. For example, for a 4.0% v/v FeNi oxyhydroxide catalyst in aqueous 30 wt % KOH (as reported in Examples 1 and 2), we mixed 4 mL of aqueous suspension containing approximately 1 g of catalyst per 100 mL of liquid with 96 mL of aqueous electrolyte containing 30 wt % KOH. Other catalysts could be mixed in varying concentrations as suspensions in water or other solutions, or the catalysts could be added directly to the aqueous electrolyte. Various mixtures of catalysts with liquids or gases fall within the scope of the invention so long as they can be recirculated through the electrolyzer stack while electric current is applied. This can be achieved with a wide range of catalysts and/or liquid solutions/suspensions of catalysts.

Disclosed herein are methods for depositing and utilizing electrocatalytic materials in situ in an electrolyzer stack or in a reactor while electrochemical reactions are occurring. The presently disclosed technology allows for deposition of catalysts inside of an electrolyzer stack without the need to open or disassemble the stack. The presently disclosed technology allows for the operation of the electrolyzer with catalysts circulating in the electrolyte.

In some embodiments, one or both of the electrodes in an electrolyzer are in contact or close proximity with the separator, thereby making it possible to form a separator electrode assembly (SEA). A separator is a permeable or semipermeable material positioned between the anode and cathode and serves to keep the electrodes separated, prevent electrical short circuits, prevent mixing of product gases, and allow the transport of ionic charge carriers between the electrodes. Separators may comprise a polymer material that should be chemically and electrochemically stable with regard to the electrolyte and its ionic charge carriers as well as the electrode materials under typical operating conditions.

Separators suitable for use with the present technology include those for use under alkaline water electrolysis conditions. Separators may comprise an open mesh and may optionally be symmetrically or asymmetrically coated with one or more polymers or inorganic oxides. Exemplary separators include those composed of an open mesh of polyphenylene sulfide fabric symmetrically coated with a mixture of polymer and zirconium oxide, such as the Zirfon UTP 500+ separator used in the Examples. Other separators suitable for use with the presently disclosed technology include Zirfon UTP 220, plain asbestos, polymer-reinforced asbestos, polytetrafluoroethylene-bonded potassium titanate, polymer-bonded zirconia, polyphenylene sulfide, Fortron®, Torcon™, Ryton®, polybenzimidazole-based polymer electrolyte membranes, anion exchange membranes, Fumasep FAA-3, Aemion+™, and Sustainion® X37.

To allow electrolyte and/or ions to permeate the separator, an electrode contacting the separator may have openings therethrough. The openings through the electrode define areas on the surface of the separator that are electrolyte exposed. In some embodiments, the electrode is a mesh composed of a plurality of intersecting conductive wires. The plurality of intersecting conductive wires may be woven into square, rectangular, rhombic, triangular, hexagonal, or other pattern. In other embodiments, the plurality of intersecting conductive wires have no pattern at all. Other exemplary electrodes, include, without limitation, a foam formed from a plurality of pores in a conductive material, a perforated or slotted conductive plate, or an expanded conductive metal.

FIGS. 2B and 2C illustrate a SEA after in situ electrocatalyst deposition. The SEA comprises an electrode 110 comprising conductive wires intersecting at a right angle in contact with a separator 100. The openings through the electrode 110 allows for electrolyte to pass through and defines areas on the surface of the separator 100 that are electrolyte-exposed. During in situ deposition of electrocatalyst, electrocatalyst 120 may be deposited on both the electrode 110 and separator 100. This allows for the electrocatalyst 120 to be in direct contact with the separator 100.

During in situ deposition, catalyst coats the electrode, forming a bridge between the electrode and the separator, and extends out onto the separator as shown in the SEM image in FIG. 24. The SEM images show that catalyst is coating the mesh as well as the separator. The SEA provides intimate connection between the electrical conductor, catalyst, and separator. This type of structure can only be formed when catalyst is deposited with both the electrode and separator present. It cannot be formed if an electrode is coated by itself with a catalyst.

As demonstrated by the Examples, deposition on the electrode and separator improves system performance. The electrons needed to drive the reactions are provided by the electrode which is in intimate contact with the catalyst, thus providing efficient electron transfer. The catalyst is also in intimate contact with the separator so it is positioned to efficiently send and receive OH⁻ ions through the separator as they are generated/consumed during the electrochemical reactions.

Hydrogen evolution electrocatalysts, oxygen evolution electrocatalysts, bifunctional hydrogen/oxygen evolution electrocatalysts, or any combination thereof may be deposited on electrodes, flow fields, separators, or any combination thereof.

The electrolytes described herein may be utilized under various voltages or current densities. The voltage or current density may be selected to allow for a gas evolution reaction and/or deposition of the electrocatalyst.

For example, single cell voltages in the range of 1.23-3 V with current densities of 0.1-5 A/cm² may be used. In electrolyzers, the HER and OER will occur simultaneously under these conditions.

For deposition, similar voltage and current ranges can be used. As demonstrated in the Examples, deposition was achieved under constant current operation at 0.25 A/cm². This typically requires a voltage of around 1.75 V. The cathode electrode may be biased at a potential of −1.75 V with respect to the anode electrode while the anode electrode may be biased at a potential of +1.75 V with respect to the cathode electrode. With the leads switched, the cathode electrode may be biased at a potential of +1.75 V with respect to the anode electrode and the anode electrode may be biased at a potential of −1.75 V with respect to the cathode electrode. The signs of the potentials for the cathode and anode are always opposite, with positive potentials producing anodic (oxidizing) current and negative potentials producing cathodic (reducing) current.

With the presently disclosed in situ method, simultaneous deposition and HER/OER may be achieved.

In one embodiment, an alkaline electrolyzer is operated as an electrochemical slurry reactor with the suspended catalysts mixed in with the recirculating electrolyte. Mixing reservoirs may be included in the recirculation loop to ensure the catalysts remain suspended.

In this embodiment, the water-suspended catalysts enable water splitting at reduced overpotentials when the catalyst makes contact or approaches the anode or cathode surface. Preliminary data may show evidence of this mechanism. As the concentration of the suspended catalysts in the recirculating alkaline electrolyte is increased, the voltage required for a given current density decreases. As demonstrated in the Examples, stable performance with various catalysts has been recorded over multiple >14 h periods at 0.25 A cm⁻².

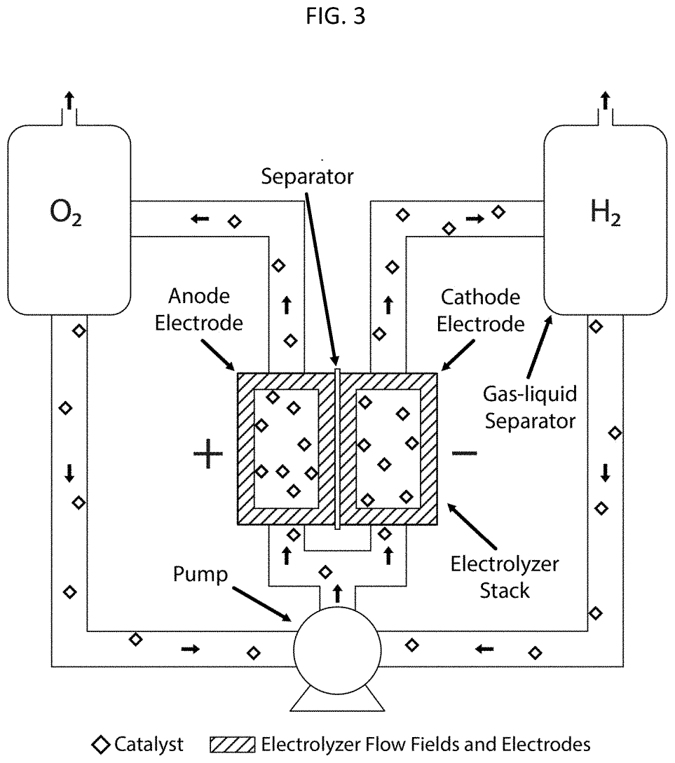

FIG. 3 illustrates an exemplary method for operating an electrolyzer as an alkaline electrochemical slurry reactor with an electrolyte having electrocatalyst therein and a single recirculation loop. Performance can be increased by recirculating electrolyte with catalysts through both the anode and cathode sides.

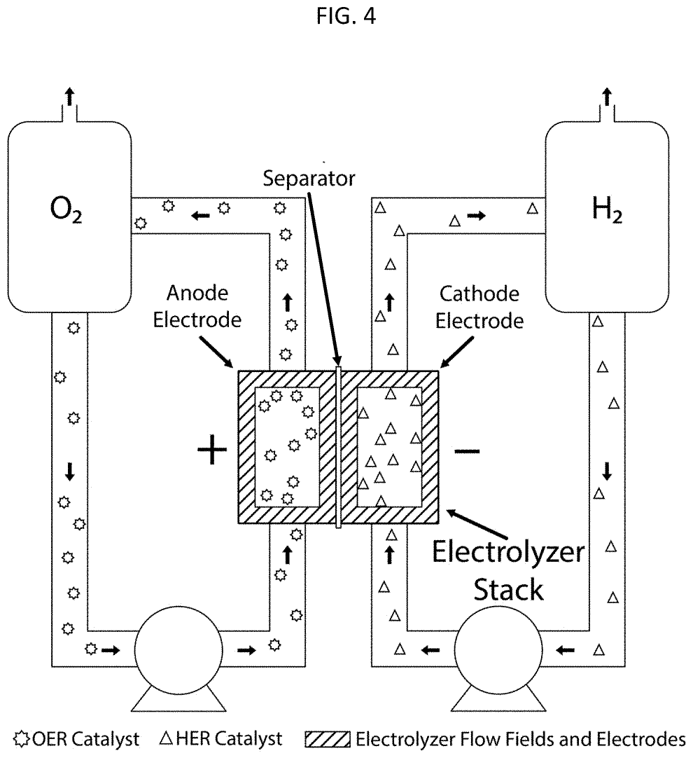

FIG. 4 illustrates an alternative embodiment for operating an electrolyzer as an alkaline electrochemical slurry reactor with two separate recirculation loops. With separate pumps, electrolyte with suspended HER or bifunctional hydrogen/oxygen evolution catalyst is recirculated on the cathode side and electrolyte with suspended OER or bifunctional hydrogen/oxygen evolution catalyst is recirculated on the anode side.

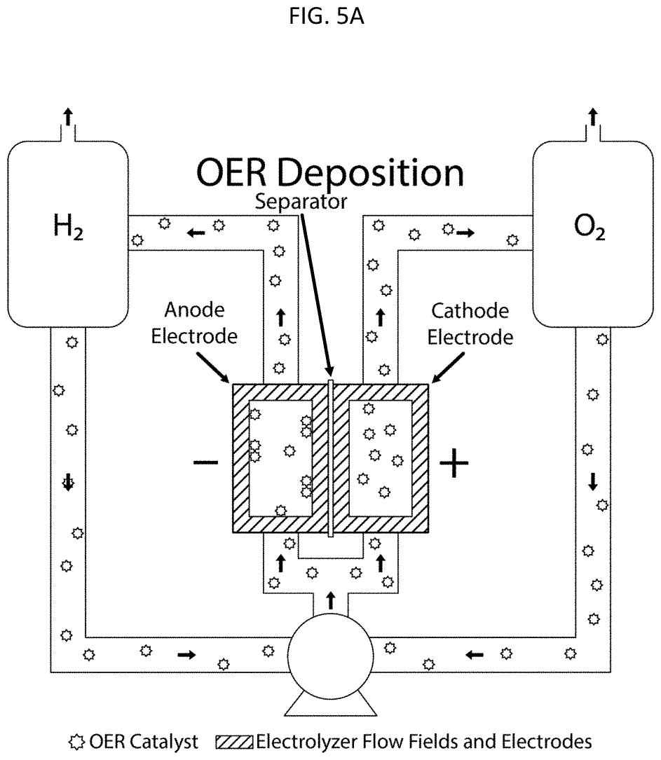

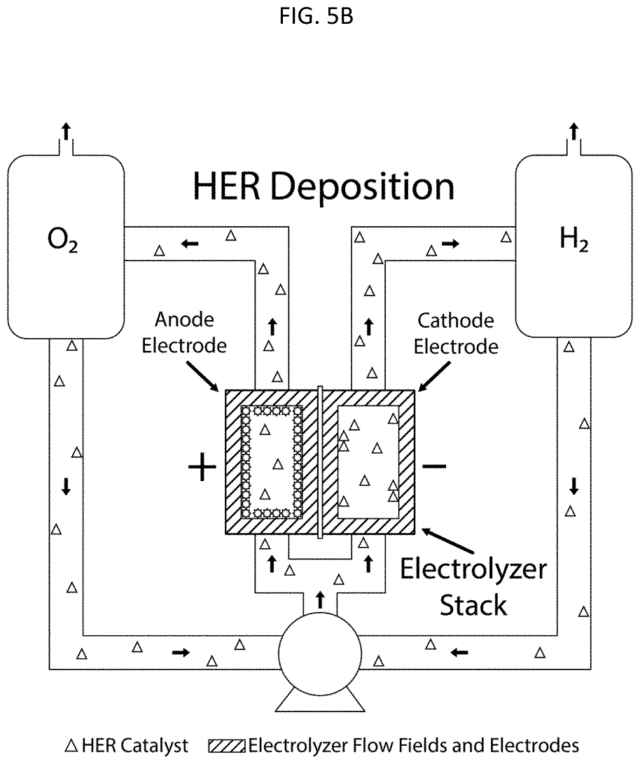

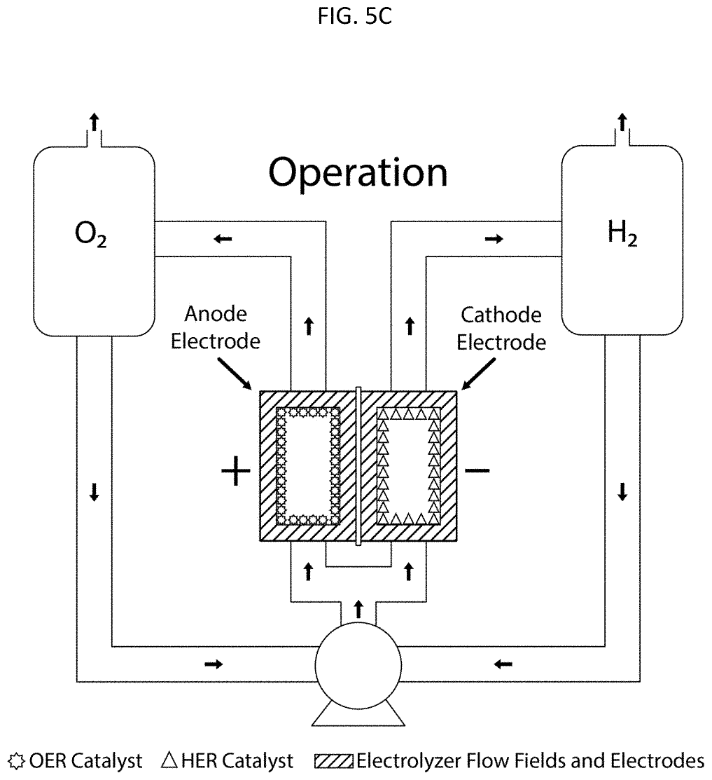

In another embodiment, the catalyst can be deposited onto the electrodes, flow fields, separators or any combination thereof in situ in an electrolyzer or in a reactor used for deposition. Deposition can occur under either negative or positive potentials and it is possible to deposit catalysts under either potential by changing the polarity for a given deposition step. For example, if the most favorable deposition for an OER catalyst occurs under negative potentials, the electrolyzer or reactor can be run with OER catalyst suspended in the electrolyte and a negative potential applied to the anode electrode as shown in FIG. 5A. This causes the anode electrode to experience negative potentials.

Next, the electrolyzer stack or reactor can be drained and refilled with electrolyte containing HER catalyst. If the most favorable deposition for the HER catalyst occurs under negative potentials a negative potential can be applied to the cathode electrode as shown in FIG. 5B. Finally, the electrolyte with suspended HER catalyst can be replaced with clean electrolyte (electrolyte without the addition of catalyst) and the electrolyzer can be operated as shown in FIG. 5C, now with the anode and cathode coated with OER and HER catalysts, respectively. The Examples demonstrate sustained improvement under such operation after FeNi OER deposition and Co HER deposition. Stable performance has been recorded over multiple >100 h runs at 0.25 A cm⁻², and no degradation in performance is seen in the chronopotentiometry data after 558 hours of operation at 0.25 A cm⁻².

In still another embodiment, performance can be improved by depositing catalysts onto the electrodes, flow fields, separators or any combination thereof in situ in an electrolyzer stack or reactor in a single step with catalyst circulating through both anode and cathode of the electrolyzer stack as shown in FIG. 3. After the deposition step, the electrolyte with suspended catalyst can be replaced with clean electrolyte and the electrolyzer is operated normally. The Examples demonstrate sustained improvement under such operation after FeNi deposition. Stable performance has been recorded for multiple >100 h runs, totaling over 6,000 hours, at current densities ranging from 0.25 A cm⁻² to 1 A cm⁻² (see, for example, FIG. 30).

The methods described can be performed with the electrolyzer stack fully assembled, which gives rise to the possibility of periodic regeneration in the field to avoid decreases in stack efficiency due to catalyst degradation. When the electrolyzer is operated as an alkaline electrochemical slurry reactor such as illustrated in either FIG. 3 or FIG. 4, the catalyst containing electrolyte could be drained, flushed with clean electrolyte if necessary, and replaced with fresh electrolyte containing the corresponding catalyst.

As illustrated in FIGS. 5A-5C, the electrolyte could be drained, and flushed with clean electrolyte if necessary, before performing the OER and/or HER deposition steps and replacing with clean electrolyte. Caution must be taken to avoid explosive mixtures of hydrogen and oxygen during any deposition steps where the anode electrode sees a negative potential because this will cause hydrogen to be produced on the normally oxygen-producing side and oxygen to be produced on the normally hydrogen-producing side.

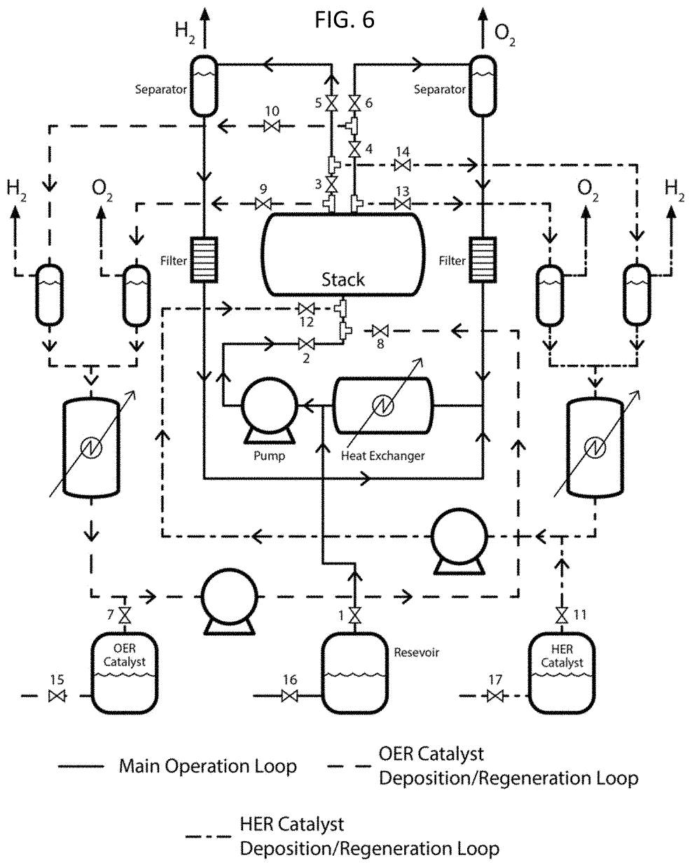

As illustrated in FIG. 6 and described in Example 3, an apparatus for periodic regeneration in the field could allow for deposition steps to occur in isolation from the main electrolyzer balance of plant to prevent buildup of catalyst particles and intermixing of hydrogen and oxygen in the system. In addition, a brief soak with acidic solution (ca. 1 M) can be employed if the previous coating needs to be cleaned or removed before regeneration.

FIG. 6 shows an exemplary electrolyzer system integrated with an apparatus for field regeneration. FIG. 6 illustrates a main recirculation loop (solid lined) for operation of the electrolyzer system that includes the electrolyzer stack, pump, filters, gas-liquid separators, and heat exchanger. Two independent recirculation loops are also included for the OER (dash-dash line) and HER (dash-dot line) catalyst deposition steps. The deposition or regeneration loops may include all of the same components as the main loop, or they may exclude the filters which could interfere with the deposition process by removing catalyst particles. The two independent recirculation loops may include different sized components than the main recirculation loop. They may also have different component arrangements. A series of valves across the whole system allow it to be operated in three different modes: electrolysis operation (solid line, FIG. 6), OER deposition/regeneration (dash-dash line, FIG. 6), and HER deposition/regeneration (dash-dot line, FIG. 6). Electrolysis operation requires valves 1, 7, 8, 9, 10, 11, 12, 13, 14, 15, 16, and 17 to be closed, and the rest of the valves to be open. This allows the electrolyte to flow only through the main system. When transitioning to a regeneration procedure, the electrolyte may be drained into the reservoir by opening valve 1. The clean electrolyte reservoir may be drained and refilled with fresh clean electrolyte (electrolyte without the addition of catalyst) as necessary using valve 16.

Valves 4, 7, 8, 9, and 10 may be opened and valves 1, 2, 3, 6, 12, 13, 15, 16, and 17 closed so that the OER catalyst suspended in electrolyte can be pumped in from the reservoir without mixing with the main recirculation or HER deposition/regeneration loops. Once the system is filled with OER catalyst suspended in electrolyte, valve 7 may be closed and the system can be operated at the relevant current density for the amount of time required to complete deposition/regeneration. The leads may be positioned for this process so that the anode electrodes experience either positive or negative potentials. Finally, valve 7 may be opened and the OER catalyst suspended in electrolyte drained back into the reservoir. The OER catalyst reservoir may be drained and refilled with fresh OER catalyst suspended in electrolyte using valve 15 as necessary. In addition, the OER catalyst reservoir tank may be equipped with a mixer to ensure the catalysts are well-suspended in the electrolyte when they are pumped into the system for deposition/regeneration.

Valves 3, 11, 12, 13, and 14 may be opened and valves 1, 2, 4, 5, 8, 9, 10, 15, 16, and 17 closed so that the HER catalyst suspended in electrolyte can be pumped in from the reservoir without mixing with the main recirculation or OER deposition/regeneration loops. Once the system is filled with HER catalyst suspended in electrolyte, valve 11 may be closed and the system can be operated at the desired current density for the amount of time required to complete deposition/regeneration. The leads may be positioned for this process so that the cathode electrodes experience either positive or negative potentials. Finally, valve 11 may be opened and the HER catalyst suspended in electrolyte may be drained back into the reservoir. The HER catalyst reservoir may be drained and refilled with fresh HER catalyst suspended in electrolyte using valve 17 as necessary. In addition, the HER catalyst reservoir tank may be equipped with a mixer to ensure the catalysts are well-suspended in the electrolyte when they are pumped into the system for deposition/regeneration.

In practice, the OER and HER recirculation loops could be fully integrated with the main system or they could be mounted on a separated skid that could be transported to the main system location for periodic field regeneration with suitable interconnections. Once the procedures for the OER catalyst and HER catalyst deposition/regeneration have been completed, clean electrolyte (electrolyte without the addition of catalyst) can be pumped into the system by opening valve 1 and the system can be operated as an electrolyzer as described above until further regeneration is required.

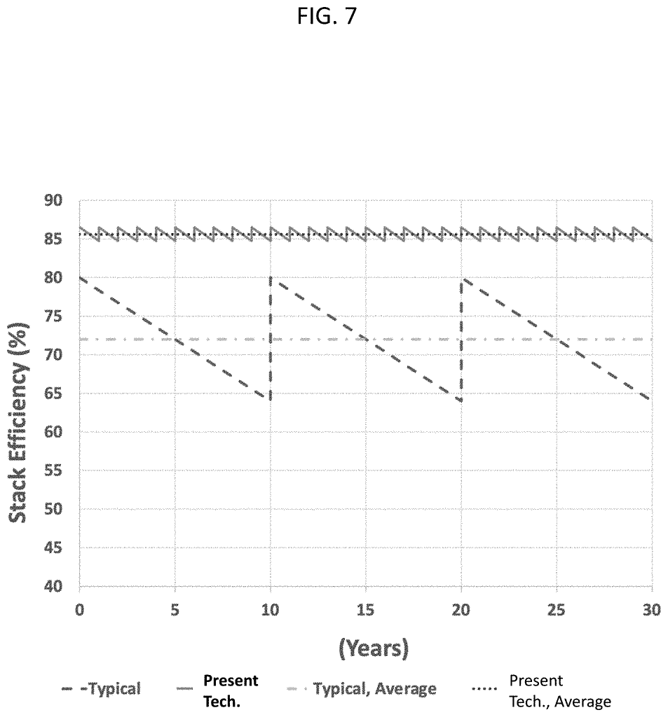

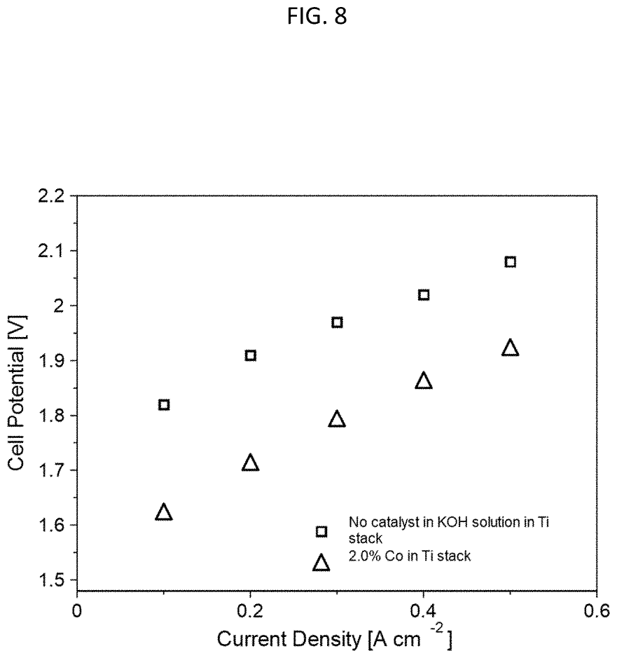

FIG. 7 shows a schematic example of operation data using in situ deposition versus the existing typical stack replacement method. Catalysts prepared using the methods disclosed in U.S. Pat. Nos. 10,196,746, and 10,961,631 allow for higher efficiency operation than typical electrolyzers, and the present technology also allows for frequent regeneration to maintain high stack efficiency.

The methods shown can, however, be used with different types of catalysts. The stack efficiency of typical electrolyzers will gradually degrade over time until stack replacement is warranted. Due to the high capital cost of stack replacement, a degradation in efficiency of 10-20% over 7 to 10 years is typically tolerated. FIG. 7 shows stack replacement at 10 year intervals and a linear decrease in efficiency during operation. In situ deposition allows for recovery of efficiency losses by frequent regeneration cycles, shown on the top curves of FIG. 7, which can be performed at a low cost. Low-cost regeneration can also be performed as desired using alkaline electrochemical slurry reactor operation by draining the catalyst suspended in electrolyte and replacing with fresh catalyst suspended in electrolyte.

Operating as an alkaline electrochemical slurry reactor could have a self-healing effect with the catalyst in the electrolyte replacing catalyst lost due to catalyst delamination/deactivation that may occur over time. In addition, self-healing could be achieved during operation by adding catalyst to the electrolyte when degradation is observed.

The presently disclosed technology is not limited to a particular type of electrolyzer or reactor such as an alkaline electrolyzer or reactor. Suitably, the present technology may also be applied to electrolyzers such as Solid Oxide Electrolyzer Cell (SOEC), Alkaline Exchange Membrane (AEM), membraneless, chlor-alkali, hydrochloric acid, urea, nitrogen, ammonia, or CO₂ electrolyzers. In addition, the technology is not limited to a particular type of electrochemical device. Suitably, the present technology may be applied to fuel cells such as solid oxide or alkaline fuel cells, as well as flow batteries or hybrid electrochemical devices.

In addition to the initial deposition of catalysts that occurs during a hydrogen evolution reaction and/or an oxygen evolution reaction catalyst, deposition that occurs during ongoing hydrogen evolution reactions and/or an oxygen evolution reactions has the effect of self-healing of the catalysts during operation of the electrolyzer.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus <10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EMBODIMENTS OF THE INVENTION

### Embodiment 1

An electrolyte comprising OH⁻ and an electrocatalyst, wherein the electrocatalyst is a hydrogen evolution electrocatalyst, an oxygen evolution electrocatalyst, a bifunctional hydrogen/oxygen evolution electrocatalyst, or any combination thereof.

### Embodiment 2

The electrolyte of embodiment 1, wherein the electrolyte comprises an effective amount of electrocatalyst for decreasing the voltage required for a hydrogen evolution reaction or an oxygen evolution reaction for a given current density.

### Embodiment 3

The electrolyte of any one of the embodiments 1-2, wherein the electrolyte comprises the hydrogen evolution electrocatalyst and the hydrogen evolution electrocatalyst comprises a metal oxyhydroxide, metal oxide, metal sulfide, metal sulfate, metal oxide-sulfide, a metal, or any combination thereof.

### Embodiment 4

The electrolyte of any one of the embodiments 1-2, wherein the electrolyte comprises the oxygen evolution electrocatalyst and the oxygen evolution electrocatalyst comprises a metal oxyhydroxide, metal oxide, metal sulfide, metal sulfate, metal oxide-sulfide, a metal, or any combination thereof.

### Embodiment 5

The electrolyte of any one of the embodiments 1-2, wherein the electrolyte comprises the bifunctional hydrogen/oxygen evolution electrocatalyst and the bifunctional hydrogen/oxygen evolution electrocatalyst comprises a metal oxyhydroxide, metal oxide, metal sulfide, metal sulfate, metal oxide-sulfide, a metal, or any combination thereof.

### Embodiment 6

The electrolyte of any one of embodiments 1-5, wherein the electrocatalyst comprises suspended particles.

### Embodiment 7

The electrolyte of embodiment 6, wherein the particles have an effective particle size of 1 nm to 10 microns.

### Embodiment 8

A separator electrode assembly comprising
an electrode, wherein the electrode comprises a plurality of openings therethrough;
a separator, wherein the electrode contacts the separator and the separator has an electrolyte-exposed surface defined by the plurality of openings; and
an electrocatalyst, wherein the electrocatalyst is deposited on the electrode and the electrolyte-exposed surface of the separator and wherein the electrocatalyst is a hydrogen evolution electrocatalyst, an oxygen evolution electrocatalyst, a bifunctional hydrogen/oxygen evolution electrocatalyst, or any combination thereof.

### Embodiment 9

The separator electrode assembly of embodiment 8, wherein the electrode comprises a mesh formed from a plurality of intersecting conductive wires.

### Embodiment 10

The separator electrode assembly of any one of embodiments 8-9, wherein the electrode is an anode comprising the oxygen evolution electrocatalyst or the bifunctional hydrogen/oxygen evolution electrocatalyst.

### Embodiment 11

The separator electrode assembly of any one of embodiments 8-9, wherein the electrode is a cathode comprising the hydrogen evolution electrocatalyst or the bifunctional hydrogen/oxygen evolution electrocatalyst.

### Embodiment 12

An alkaline electrolyzer comprising the electrolyte according to any one of embodiments 1-7 and an electrode.

### Embodiment 13

An alkaline electrolyzer comprising an electrolyte and the separator electrode assembly according to any one of embodiments 8-11.

### Embodiment 14

An alkaline electrolyzer comprising the electrolyte according to any one of embodiments 1-7 and the separator electrode assembly according to any one of embodiments 8-11.

### Embodiment 15

A reactor system comprising the electrolyzer according to any one of embodiments 12-14 and a pump configured to circulate the electrolyte through the electrolyzer.

### Embodiment 16

The reactor system of embodiment 15, wherein the pump is configured to circulate the electrolyte through a reaction recirculation loop.

### Embodiment 17

The reactor system of embodiment 15, wherein the pump is configured to circulate the electrolyte through a deposition recirculation loop.

### Embodiment 18

The reactor system of embodiment 15, wherein the pump comprises a cathode deposition pump configured to circulate the hydrogen evolution electrocatalyst or bifunctional hydrogen/oxygen evolution electrocatalyst through a cathode deposition recirculation loop and an anode deposition pump configured to circulate the oxygen evolution electrocatalyst or bifunctional hydrogen/oxygen evolution electrocatalyst through an anode deposition recirculation loop.

### Embodiment 19

A method for depositing an electrocatalyst, the method comprising recirculating the electrolyte according to any one of embodiments 1-7 through an electrolyzer under conditions sufficient for depositing the electrocatalyst onto an electrode.

### Embodiment 20

The method of embodiment 19, wherein the electrode comprises a plurality of openings therethrough and the electrode contacts a separator, wherein the separator has an electrolyte-exposed surface defined by the plurality of openings, and wherein the electrocatalyst is deposited on to the electrode and the electrolyte-exposed surface of the separator.

### Embodiment 21

The method of any one of embodiments 19-20, wherein the electrolyte is recirculated through a reaction recirculation loop.

### Embodiment 22

The method of embodiment 21, wherein deposition occurs simultaneously with a hydrogen evolution reaction or an oxygen evolution reaction.

### Embodiment 23

The method of any one of embodiments 19-20, wherein the electrolyte is recirculated through a deposition recirculation loop.

### Embodiment 24

The method of embodiment 23, wherein deposition occurs before, during, and/or after a hydrogen evolution reaction or an oxygen evolution reaction without the need to shut down, disassemble, or reassemble the electrolyzer.

### Embodiment 25

The method of any one of embodiments 19-20, wherein the hydrogen evolution electrocatalyst or bifunctional hydrogen/oxygen evolution electrocatalyst is recirculated through a cathode deposition recirculation loop and the oxygen evolution electrocatalyst or bifunctional hydrogen/oxygen evolution electrocatalyst is recirculated through an anode deposition recirculation loop.

### Embodiment 26

The method of embodiment 25, wherein deposition occurs before, during, and/or after a hydrogen evolution reaction or an oxygen evolution reaction without the need to shut down, disassemble, or reassemble the electrolyzer.

### Embodiment 27

The method of any one of embodiments 19-26 further comprising draining the electrolyte from the electrolyzer and replacing the electrolyte with a second electrolyte, wherein the second electrolyte lacks an electrocatalyst or wherein the second electrolyte comprises an electrocatalyst different than the electrocatalyst in the electrolyte.

### Embodiment 28

The method of embodiment 27, further comprising reversing the polarity of voltage applied across the electrolyzer after replacing the electrolyte with the second electrolyte.

### EXAMPLES

All data was obtained while operating at 80° C. and atmospheric pressure unless otherwise specified.

### Example 1

FeNi oxyhydroxide catalyst referenced in U.S. Pat. Nos. 10,196,746 and 10,961,631 was utilized in alkaline electrochemical slurry operation (see FIG. 3) with deposition, anode electrode positive, in a bench-scale electrolyzer with stainless steel endplates/flow fields and 1.2 cm² Ni mesh electrodes. The FeNi catalyst (as a suspension obtained from the synthesis method referenced in U.S. Pat. No 10,196,746) was mixed at 4% v/v with an aqueous 30 wt % KOH solution and pumped into the system. Using this method, sodium nitrate was also present in the aqueous suspension in the range of approximately 0.01 to 1 M. Unreacted metal precursor compounds (nickel and/or iron nitrates) and/or gelling agents (sodium bicarbonate) may have also been present in the aqueous suspension.

The electrolyte containing catalyst was recirculated through the electrolysis system while applying 0.3 A (0.25 A cm⁻²) for 72 hours (FIG. 21) to deposit FeNi catalyst while simultaneously producing hydrogen and oxygen with improved efficiency compared to operation with uncoated nickel mesh electrodes and clean electrolyte (electrolyte without the addition of catalyst). After operation with deposition, the 4% v/v FeNi in aqueous 30 wt % KOH solution was replaced with clean aqueous 30 wt % KOH solution (KOH solution without the addition of catalyst) and 0.3 A (0.25 A cm⁻²) was applied for 297 hours (FIG. 22). Chronopotentiometry at various current levels was performed after 425 hours, 1394 hours, and 5361 hours of operation with clean electrolyte (FIG. 23). Electrolyzer operation has been continued for over 6,000 hours (FIG. 30), showing good stability with clean electrolyte after electrochemical slurry deposition. Some irregularities are associated with brief power outages.

### Example 2

FeNi oxyhydroxide catalyst referenced in U.S. Pat. Nos. 10,196,746 and 10,961,631 was utilized with anode electrode negative, in a bench-scale electrolyzer with stainless steel endplates/flow fields and 1.2 cm² Ni mesh electrodes. The FeNi catalyst (as a suspension obtained from the synthesis method referenced in U.S. Pat. No. 10,196,746) was mixed at varying percentages with an aqueous 30 wt % KOH solution and pumped into the system.

Chronopotentiometry at different current levels was performed with 0%, 0.25%, 0.75%, 1.5%, 2.0%, and 4.0% FeNi catalyst in aqueous 30 wt % KOH solution (FIG. 13). The electrolyzer was first operated with no catalyst for two 0.1-0.5 A chronopotentiometry runs (not shown) with the anode electrode positive, then the anode electrode was switched to negative. With the anode electrode negative, two 0.1-0.5 A chronopotentiometry runs were performed with no catalyst (run with lowest voltage is shown in FIG. 13). The electrolyzer was then operated with 0.25% v/v FeNi catalyst in aqueous 30 wt % KOH for two 0.1-0.5 A chronopotentiometry runs (run with lowest voltage is shown in FIG. 13). The concentration of FeNi catalyst was increased to 0.75% v/v in aqueous 30 wt % KOH for four 0.1-0.5 A chronopotentiometry runs (run with lowest voltage is shown in FIG. 13). The concentration of FeNi catalyst was increased to 1.5% v/v in aqueous 30 wt % KOH for two 0.1-0.5 A chronopotentiometry runs followed by chronopotentiometry at 0.3 A for 15 hours (shown in FIG. 14) and an additional four 0.1-0.5 A chronopotentiometry runs (run with lowest voltage is shown in FIG. 13). The concentration of FeNi catalyst was increased to 2.0% v/v in aqueous 30 wt % KOH for two 0.1-0.5 A chronopotentiometry runs (run with lowest voltage is shown in FIG. 13), then to 4.0% v/v for two 0.1-0.5 A chronopotentiometry runs followed by chronopotentiometry at 0.3 A for 23 hours (shown in FIG. 15) and an additional 0.1-0.5 A chronopotentiometry run (run with lowest voltage is shown in FIG. 13).

Following this sequence, FeNi had been deposited onto the electrodes and the 4.0% v/v FeNi in aqueous 30 wt % KOH solution was then drained from the electrolyzer and replaced with 2.0% v/v Co (as a suspension obtained from the synthesis method referenced in U.S. Pat. No. 10,196,746) in aqueous 30 wt % KOH solution. The anode electrode was switched to positive for two 0.1-0.5 A chronopotentiometry runs (not shown) followed by chronopotentiometry at 0.3 A for 76 hours (not shown) and an additional two 0.1-0.5 A chronopotentiometry runs (run with lowest voltage is shown in FIG. 17). Then, the 2.0% v/v Co in aqueous 30 wt % KOH solution was drained from the electrolyzer and replaced with clean aqueous 30 wt % KOH solution (KOH solution without the addition of catalyst). With the anode electrode positive, chronopotentiometry at 0.3 A was performed for 222 hours elapsed time (FIG. 18 shows hours 41-167) followed by two 0.1-0.5 A chronopotentiometry runs and one 0.1-2 A chronopotentiometry run with each current applied for 10 minutes (0.1-0.5 A shown in FIG. 17). With anode electrode positive, chronopotentiometry at 0.3 A for an additional 336 hours (FIG. 19 shows last 168 hours) followed by one 0.1-2 A chronopotentiometry run with each current applied for 10 minutes (0.1-0.5 A shown in FIG. 17).

After the total of 558 hours of operation with clean electrolyte, the electrolyzer was disassembled to reveal the formation of an integrated Separator Electrode Assembly (FIGS. 24 and 25). The anode electrode was bonded to the separator and had to be peeled away from the Zirfon UTP-500+ separator by hand while the cathode remained fixed on the separator, and both the anode and cathode were analyzed via scanning electron microscopy (SEM, shown in FIGS. 24-29).

### Example 3

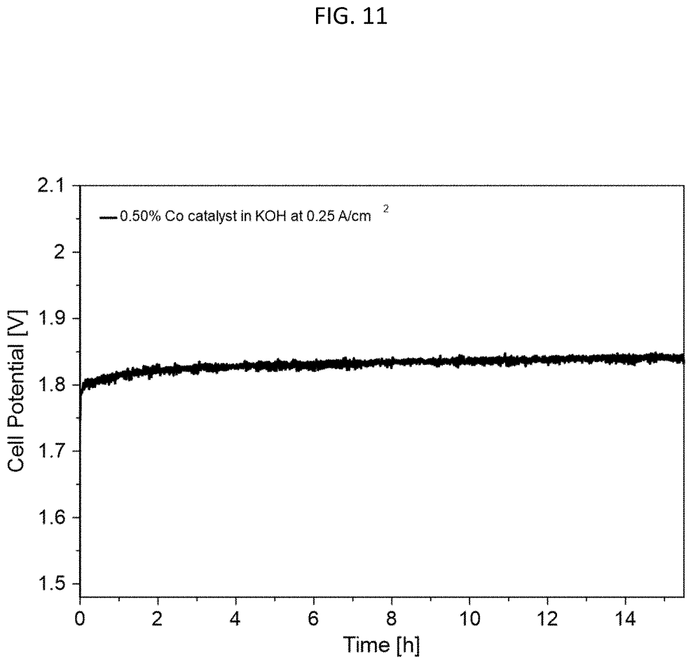

Co oxyhydroxide catalyst referenced in U.S. Pat. Nos. 10,196,746 and 10,961,631 was utilized for in situ deposition, anode electrode positive, in a bench-scale electrolyzer with stainless steel endplates/flow fields and 1.2 cm² Ni mesh electrodes. The electrolyzer was first operated with no catalyst for four 0.1-0.5 A chronopotentiometry runs (not shown) to establish a baseline. The Co catalyst (as a suspension obtained from the synthesis method referenced in U.S. Pat. No. 10,196,746) was mixed at 0.1% v/v with the aqueous 30 wt % KOH solution in the electrolyzer. The electrolyzer was then operated with 0.1% v/v Co catalyst in aqueous 30 wt % KOH for 1 hour at 0.3 A (not shown) followed by one 0.1-0.5 A chronopotentiometry run (not shown). The concentration of Co catalyst was increased to 0.25% v/v in aqueous 30 wt % KOH and the electrolyzer was operated for 24 hours at 0.3 A (not shown) followed by one 0.1-0.5 A chronopotentiometry run (not shown). The concentration of Co catalyst was increased to 0.50% v/v in aqueous 30 wt % KOH and the electrolyzer was operated for two 0.1-0.5 A chronopotentiometry runs (not shown) before 16 hours of chronopotentiometry at 0.3 A (FIG. 11). Then, three additional 0.1-0.5 A chronopotentiometry runs were performed with 0.50% v/v Co catalyst in aqueous 30 wt % KOH solution (not shown). The concentration of Co catalyst was increased to 0.75% v/v in aqueous 30 wt % KOH and the electrolyzer was operated for five 0.1-0.5 A chronopotentiometry runs (not shown). The concentration of Co catalyst was increased to 1.25% v/v in aqueous 30 wt % KOH and the electrolyzer was operated for three 0.1-0.5 A chronopotentiometry runs (not shown), then for one 0.1-0.5 A chronopotentiometry run with each current (0.1, 0.2, 0.3, 0.4, and 0.5) applied for 10 minutes each (not shown), followed by one 0.1-0.5 A chronopotentiometry run (not shown). The concentration of Co catalyst was increased to 2.0% v/v in aqueous 30 wt % KOH and the electrolyzer was operated for three 0.1-0.5 A chronopotentiometry runs (not shown), then for one 0.1-0.5 A chronopotentiometry run with each current applied for 9 minutes each (not shown), followed by one 0.1-0.5 A chronopotentiometry run (not shown) before 24 hours of chronopotentiometry at 0.3 A (FIG. 12). Then, the anode was switched to negative and four 0.1-0.5 A chronopotentiometry runs were performed with 2.0% v/v Co catalyst in aqueous 30 wt % KOH solution (not shown) followed by two 0.1-0.5 A chronopotentiometry runs (run with lowest voltage is shown in FIG. 16). Then, 0.25% FeNi v/v was added to the aqueous 30 wt % KOH solution to make 2.0% Co/0.25% FeNi and two 0.1-0.5 A chronopotentiometry runs were performed with anode electrode negative (run with lowest voltage is shown in FIG. 16) followed by chronopotentiometry at 0.3 A for 1 hour with anode electrode negative (not shown). Then, 0.75% FeNi v/v was added to the aqueous 30 wt % KOH solution to make 2.0% Co/0.75% FeNi and two 0.1-0.5 A chronopotentiometry runs were performed with anode electrode negative (run with lowest voltage is shown in FIG. 16) followed by two 0.1-0.5 A chronopotentiometry runs with anode electrode switched to positive (run with lowest voltage is shown in FIG. 16).

### Example 4

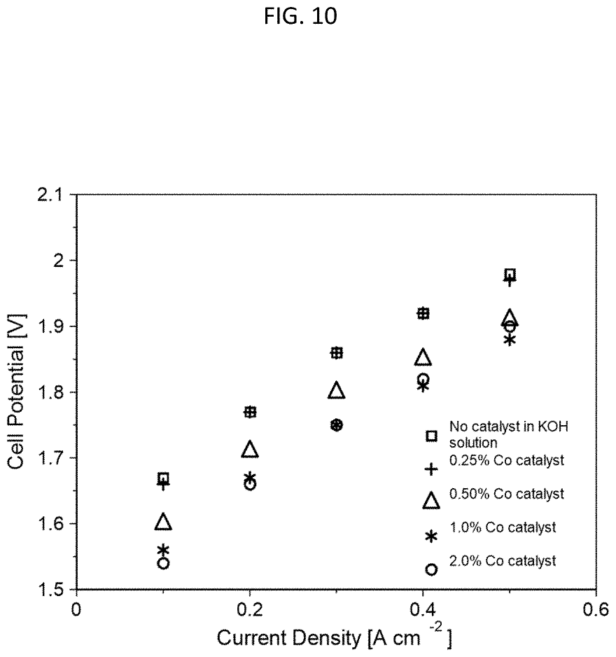

Increasing the concentration of suspended catalysts in the recirculating electrolyte results in a decrease in the voltage required for a given current density as shown in FIGS. 8, 10, 13, and 16.

### Example 5

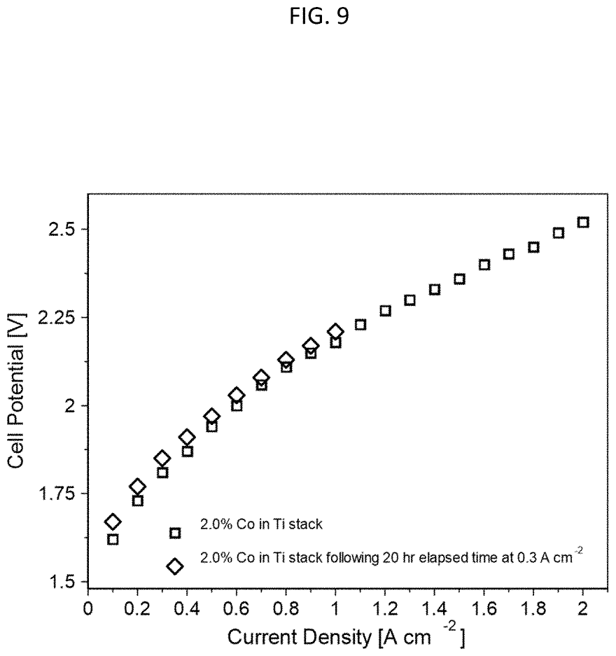

The methods and systems disclosed herein allow for stable performance as shown in FIGS. 9, 11, 12, 14, and 15.

### Example 6

FIGS. 17 and 20 show no degradation in performance is seen in the chronopotentiometry data after 558 hours of operation at 0.25 A cm⁻².

### Example 7

FIGS. 18 and 19 show stable performance after in situ deposition followed by operation with clean electrolyte over multiple >100 h runs at 0.25 A cm².

### Example 8

FIG. 21 shows the improvement in performance from deposition with a positive potential applied to the anode electrode and 4% v/v FeNi oxyhydroxide catalyst in aqueous 30 wt % KOH recirculated through the stack while applying constant current at 0.25 A cm⁻² for 72 hours.

### Example 9

FIG. 22 shows stable performance over a 297 hour run with clean 30 wt % KOH electrolyte (KOH electrolyte without the addition of catalyst), following the 72 hour FeNi deposition. FIG. 23 shows chronopotentiometry data after 425 hours, 1394 hours, and 5361 hours elapsed operating time with clean 30 wt % KOH electrolyte, following the 72 hour FeNi deposition.

### Example 10

Lifetime testing for about 8.5 months. A sample was prepared as in FIG. 21 with Configuration 1 chronopotentiometry showing 72 hour deposition with 4% v/v FeNi catalyst in aqueous 30 wt % KOH solution with anode electrode positive. The system was drained and refilled with clean 30 wt % aqueous KOH solution. Data shown in FIG. 30 (circles) is lifetime testing with clean electrolyte the entire time. The data was obtained in a bench-scale electrolyzer with stainless steel endplates/flow fields and 1.2 cm² Ni mesh electrodes at 0.3 A (0.25 A cm⁻²) for elapsed time of 5,361 hours. Following lifetime testing at 0.3 A (0.25 A cm⁻²), the electrolyzer was operated for 411 hours at 1 A cm⁻² (FIG. 39) followed by an additional 448 hours at 1 A cm⁻² for a total of 859 hours (FIG. 30, asterisks). Some irregularities are associated with brief power outages.

### Example 11

To determine the nature of the bonding between the catalyst and the electrodes, a sample was created by depositing catalyst for 2 hours with 4% v/v FeNi catalyst in aqueous 30 wt % KOH electrolyte while stirring in an alkaline electrolysis test cell as shown in FIG. 40a. Chronopotentiometry at different current levels was performed (FIG. 31, circles) before replacing with clean electrolyte. Another chronopotentiometry set was performed (FIG. 31, triangles) with the clean electrolyte while stirring. The electrodes were removed from the liquid electrolyte for 10 minutes before being re-immersed in the clean KOH electrolyte. A final chronopotentiometry set was performed while stirring (FIG. 31, X shapes). Results suggest something other than solely electrostatic bonds since catalysts stayed bonded to electrodes when removed from KOH electrolyte when no appreciable potential could be present.

### Example 12

To further determine the nature of the bonding between the catalyst and the electrodes, FeNi catalyst was deposited in situ with an anode held at negative potentials for various times at various concentrations. The system was then drained and filled with 2% v/v Co catalyst in aqueous 30 wt % KOH electrolyte. The sample was then deposited with Co catalyst in situ for 76 hours with the anode held at positive potentials. The system was drained and refilled with clean KOH electrolyte and run with anode still held at positive potentials for 558 hours. The system was drained, and the electrodes were removed and rinsed with ultrapure water. The anode was peeled away from the SEA for imaging. SEM and Energy Dispersive X-ray Spectroscopy (EDS) imaging was done on both anode and cathode side. SEM micrographs are shown in FIGS. 32-37, with regions analyzed by EDS shown in inset boxes. SEM images and EDS images were obtained using a FEI Versa 3D Dual Beam SEM. Percent cobalt present on the rinsed anodes and cathodes is presented in Table 1.

TABLE 1
Percent cobalt determined by EDS on rinsed anodes and cathodes
at three magnifications. The mean percent cobalt detected
at the three magnifications was calculated.

| | | Scale bar | | | Mean | |
|---|---|---|---|---|---|---|
| FIG. | Sample condition | (μm) | % Co | Stdev | % Co | Stdev |
| 32 | Anode rinsed | 250 | 7.6 | 0.6 | 8.0 | 0.84 |
| 33 | Anode rinsed | 25 | 9.0 | 0.6 | | |
| 32 | Anode rinsed | 5 | 7.5 | 0.6 | | |
| 33 | Cathode rinsed | 250 | 2.2 | 1.0 | 7.7 | 4.5 |
| 34 | Cathode rinsed | 25 | 7.6 | 1.0 | | |
| 35 | Cathode rinsed | 5 | 13.3 | 1.0 | | |

This data shows that cobalt is present on both anode and cathode at an average of 8.0±0.84% and 7.7±4.5%, respectively. This cobalt is still bonded after running for 558+ hours and remained on the cathode and anode after rinsing. Though deposition was performed while the anode was held at a positive potential, and remaining positive, cobalt was still observed across both the anode and the cathode, indicating that the mechanism of deposition is not driven solely by electrostatic forces.

### Example 13

A sample was created by stirring for 3 hours and 40 minutes at 80° C. with 4% v/v FeNi catalyst in aqueous 30 wt % KOH electrolyte with no applied potential using an alkaline electrolysis test cell as shown in FIG. 40A. The electrolyte containing 4% v/v FeNi catalyst was removed and replaced with clean electrolyte. A chronopotentiometry set was performed (FIG. 38). Comparing the performance of the sample created without applied potential (circles) to the typical performance of a sample generated with applied potential (triangles), these results show improvement of performance, and therefore bonding of catalyst, even though no potential was applied when FeNi catalyst was present in electrolyte.

### Example 14

To demonstrate regeneration with FeNi catalyst, a sample was created by depositing with 4% v/v FeNi catalyst in aqueous 30 wt % KOH electrolyte while stirring in an alkaline electrolysis test cell as shown in FIG. 40B. After deposition, the electrolyte containing 4% v/v FeNi catalyst was removed and replaced with clean electrolyte. An increase in voltage was observed over time as shown in FIG. 41. Regeneration was achieved via the addition of 4% v/v FeNi catalyst to the clean electrolyte, resulting in a voltage drop shown at approximately 237 hours in FIG. 41.

We claim:

1. An electrolyte comprising OH⁻ and an electrocatalyst, wherein the electrocatalyst is a hydrogen evolution electrocatalyst, an oxygen evolution electrocatalyst, a bifunctional hydrogen/oxygen evolution electrocatalyst, or any combination thereof.

2. The electrolyte of claim 1, wherein the electrolyte comprises an effective amount of electrocatalyst for decreasing the voltage required for a hydrogen evolution reaction or an oxygen evolution reaction for a given current density.

3. The electrolyte of claim 1, wherein the electrocatalyst comprises suspended particles.

4. A separator electrode assembly comprising
an electrode, wherein the electrode comprises a plurality of openings therethrough;
a separator, wherein the electrode contacts the separator and the separator has an electrolyte-exposed surface defined by the plurality of openings; and
an electrocatalyst, wherein the electrocatalyst is deposited on to the electrode and/or the electrolyte-exposed surface of the separator and wherein the electrocatalyst is a hydrogen evolution electrocatalyst, an oxygen evolution electrocatalyst, a bifunctional hydrogen/oxygen evolution electrocatalyst, or any combination thereof.

5. The separator electrode assembly of claim 4, wherein the electrode comprises a mesh formed from a plurality of intersecting conductive wires, a foam formed from a plurality of pores in a conductive material, a slotted or perforated conductive plate, or expanded metal.

6. An alkaline electrolyzer comprising the electrolyte according to any one of claim 1 and an electrode.

7. An alkaline electrolyzer comprising an electrolyte and the separator electrode assembly according to claim 4.

8. The alkaline electrolyzer of claim 7, wherein the electrolyte comprises OH⁻ and the electrocatalyst.

9. A reactor system comprising the electrolyzer according to claim 6 and a pump configured to circulate the electrolyte through the electrolyzer.

10. The reactor system of claim 9, wherein the pump is configured to circulate the electrolyte through a reaction recirculation loop or a deposition recirculation loop.

11. The reactor system of embodiment 9, wherein the pump comprises a cathode deposition pump configured to circulate the hydrogen evolution electrocatalyst or bifunctional hydrogen/oxygen evolution electrocatalyst through a cathode deposition recirculation loop and an anode deposition pump configured to circulate the oxygen evolution electrocatalyst or bifunctional hydrogen/oxygen evolution electrocatalyst through an anode deposition recirculation loop.

12. A method for depositing an electrocatalyst, the method comprising recirculating the electrolyte according to claim 1 through an electrolyzer under conditions sufficient for depositing the electrocatalyst onto an electrode.

13. The method of claim 12, wherein the electrode comprises a plurality of openings therethrough and the electrode contacts a separator, wherein the separator has an electrolyte-exposed surface defined by the plurality of openings, and wherein the electrocatalyst is deposited on to the electrode and the electrolyte-exposed surface of the separator.

14. The method of claim 12, wherein the electrolyte is recirculated through a reaction recirculation loop.

15. The method of claim 14, wherein deposition occurs simultaneously with a hydrogen evolution reaction or an oxygen evolution reaction.

16. The method of claim 12, wherein the electrolyte is recirculated through a deposition recirculation loop.

17. The method of claim 16, wherein deposition occurs before, during, and/or after a hydrogen evolution reaction or an oxygen evolution reaction without the need to shut down, disassemble, or reassemble the electrolyzer.

18. The method of claim 12, wherein the hydrogen evolution electrocatalyst or bifunctional hydrogen/oxygen evolution electrocatalyst is recirculated through a cathode deposition recirculation loop and the oxygen evolution electrocatalyst or bifunctional hydrogen/oxygen evolution electrocatalyst is recirculated through an anode deposition recirculation loop.

19. The method of claim 18, wherein deposition occurs before, during, and/or after a hydrogen evolution reaction or an oxygen evolution reaction without the need to shut down, disassemble, or reassemble the electrolyzer.

20. The method of claim 12 further comprising draining the electrolyte from the electrolyzer and replacing the electrolyte with a second electrolyte, wherein the second electrolyte lacks an electrocatalyst or wherein the second electrolyte comprises an electrocatalyst different than the electrocatalyst in the electrolyte.
